(19) United States
(12) Patent Application Publication
(10) Pub. No.: US 2025/0120791 A1
(43) Pub. Date: Apr. 17, 2025

(54) SYSTEMS AND METHODS FOR PRECISE MOVEMENT OF TEETH

(71) Applicant: Celebrace Inc., Plano, TX (US)

(72) Inventor: Mehdi Peikar, Dallas, TX (US)

(73) Assignee: Celebrace Inc., Plano, TX (US)

(21) Appl. No.: 18/915,313

(22) Filed: Oct. 14, 2024

Related U.S. Application Data
(60) Provisional application No. 63/544,478, filed on Oct. 17, 2023.

(51) Int. Cl. A61C 7/14

(52) U.S. Cl. CPC A61C 7/146; A61C 2201/00

(57) ABSTRACT

A system can include a wire extending along a plane, including a plurality of treatment members on the plane and a plurality of brackets to be located on a plurality of teeth of a patient, each of the plurality of brackets to be coupled to the wire. The wire can have a first thickness at a first location and a second thickness at a second location, the first thickness and the second thickness being different. The wire and the plurality of treatment members can be a monolithic apparatus formed from a sheet comprising a metallic material.

### CROSS-REFERENCE TO RELATED APPLICATIONS

This application claims the benefit of and priority to U.S. Provisional Patent Application No. 63/544,478, filed Oct. 17, 2023, which is incorporated herein by reference in its entirety.

### TECHNICAL FIELD

The present implementations relate generally to precise movement of teeth, specifically an orthodontic system to achieve precise movement of teeth.

### BACKGROUND

Conventional orthodontic systems offer limited customization in terms of force, movement, and/or direction applied to individual teeth. For example, hooks, conventionally used for teeth alignment, are typically manually added to a wire or brackets (e.g., on the teeth). This can limit force, movement, and/or direction orthodontists and dentists can apply to the teeth.

### SUMMARY

The systems and methods as described herein can enable precise movement of teeth of a patient, such as transitioning teeth from an overjet treatment arch (OTA) to a final treatment arch (FTA). Each tooth of the patient can have an ideal position to achieve both functional and aesthetic purposes. For example, molars on an upper arch (e.g., top row of teeth) and molars on a lower arch (e.g., bottom row of teeth) should be aligned to balance pressure induced by biting and mitigate stress on individual teeth or a jaw of the patient. Teeth in a non-ideal position may be moved to the ideal position by precise movement of teeth. The precise movement of teeth can be achieved through an orthodontic system. The orthodontic system can include a plurality of brackets, a wire, and a plurality of treatment members. The wire and the plurality of treatment members can be a monolithic apparatus formed from a single sheet. The wire and the plurality of treatment members may be located on a same plane. A location of the plurality of treatment members along the wire can be determined based on desired tooth movement within the teeth of the patient. A type of the plurality of treatment members can also be determined based on the desired tooth movement. The wire and the plurality of treatment members can be integrated into the monolithic apparatus to enable precise teeth movement by applying specific force based on the teeth of the patient. The wire and the plurality of treatment members can also prevent unnecessary tooth movement to reduce a risk of root resorption and shorten an orthodontic treatment time.

One aspect of the present disclosure is directed towards a system including a wire extending along a plane, including a plurality of treatment members on the plane. The system can also include a plurality of brackets to be located on a plurality of teeth of a patient, each of the plurality of brackets to be coupled to the wire where the wire has a first thickness at a first location and a second thickness at a second location, the first thickness and the second thickness being different and the wire and the plurality of treatment members are a monolithic apparatus formed from a sheet comprising a metallic material.

In some embodiments, the plurality of treatment members include one or more loops, the one or more loops continuous with the wire including a first curved portion extending in a first direction on the plane and a second curved portion extending in a second direction opposite the first direction. The plurality of treatment members can include one or more hooks including a first portion extending from the wire at a first angle between 30 to 80 degrees, inclusive, relative to the wire on the plane and a second portion extending from the first portion at a second angle between 30 to 90 degrees, inclusive, relative to the first portion on the plane. The plurality of treatment members can include one or more first protrusions and one or more second protrusions where the one or more first protrusions extend from the wire on the plane and face the plurality of teeth and the one or more second protrusions extend from the wire on the plane and face away from the plurality of teeth.

In some embodiments, the wire includes one or more curved segments, the one or more curved segments aligning with a positioning of the plurality of teeth. The plurality of treatment members can include one or more aligners continuous with the wire including a first curved portion and a second curved portion continuous with the first curved portion where the first curved portion and the second curved portion define a receiving space comprising a protrusion and the receiving space is configured to receive at least one of the plurality of teeth, and the first curved portion and the second curved portion configured to extend to the at least one of the plurality of teeth. The plurality of treatment members can include one or more first markers and one or more second markers aligned with the plurality of brackets where the one or more second markers extend from the wire and face away from the plurality of teeth, the second markers including apertures. The wire can include a first bar, a second bar parallel to the first bar, and an aperture between the first bar and the second bar, the first bar and the second bar continuous with the wire. The plurality of treatment members can include one or more links including a protrusion extending from the wire in a first direction on the plane, a first curved portion extending from the protrusion in a second direction on the plane, a second curved portion extending from the first curved portion in a third direction opposite the second direction, a straight portion extending from the second curved portion in the first direction, and a circular portion extending from the straight portion and around an aperture, the aperture configured to couple to at least one of the plurality of brackets.

In some embodiments, the plurality of brackets includes a plurality of slots, the plurality of slots having a first portion and a second portion, the first portion having a first height and the second portion having a second height, the second height greater than the first height. The plane can be an imaginary plane. The metallic material can be nickel titanium. The wire can further include a first identifier located at a first end of the wire, a second identifier located at a second end of the wire, and a third identifier located at a midpoint on the wire between the first end and the second end.

Another aspect of the present disclosure is directed towards a system. The system can include a wire extending along a plane including a plurality of treatment members on the plane, a first identifier located at a first end of the wire, a second identifier located at a second end of the wire, a third identifier located at a midpoint on the wire between the first end and the second end, and a plurality of brackets to be located on a plurality of teeth of a patient, each of the plurality of brackets to be coupled to the wire, the plurality of brackets comprising a plurality of slots, the plurality of slots having a first portion and a second portion, the first portion having a first height and the second portion having a second height, the second height greater than the first height where the wire has a first thickness at a first location and a second thickness at a second location, the first thickness and the second thickness being different and the wire and the plurality of treatment members are a monolithic apparatus comprising a metallic material.

In some embodiments, the metallic material is nickel titanium. A portion of the plurality of treatment members can be continuous with the wire and a portion of the plurality of treatment members extend from the wire on the plane, the plurality of treatment members configured to align the plurality of teeth with the wire. The system can be designed by a machine learning model.

Another aspect of the present disclosure is directed towards a method. The method can include forming a monolithic apparatus including a wire with a plurality of treatment members on a single plane, placing a plurality of brackets on a plurality of teeth of a patient, and coupling the wire to the plurality of brackets. The monolithic apparatus can be formed from a sheet comprising a metallic metal, the monolithic apparatus formed by at least one of laser cutting, water jet cutting, stamping, or electric discharge machining of the sheet. The monolithic apparatus can be 3D printed.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 is a schematic diagram of an example system in accordance with present implementations.

FIG. 2 is a top view of an example wire in accordance with present implementations.

FIG. 3 is a perspective view of the wire of FIG. 2, in accordance with present implementations.

FIG. 4 is a top view of an example wire in accordance with present implementations.

FIG. 5 is a perspective view of the wire of FIG. 4, in accordance with present implementations.

FIG. 6 is a top view of an example wire in accordance with present implementations.

FIG. 7 is a perspective view of the wire of FIG. 6, in accordance with present implementations.

FIG. 8 is a top view of an example wire in accordance with present implementations.

FIG. 9 is a perspective view of the wire of FIG. 8, in accordance with present implementations.

FIG. 10 is a top view of an example wire in accordance with present implementations.

FIG. 11 is a perspective view of the wire of FIG. 10, in accordance with present implementations.

FIG. 12 is a top view of an example wire in accordance with present implementations.

FIG. 13 is a top view of the wire of FIG. 12 including a plurality of rings, in accordance with present implementations.

FIG. 14 is a closeup view of the wire of FIG. 12, in accordance with present implementations.

FIG. 15 is a top view of an example wire in accordance with present implementations.

FIG. 16 is a top view of example wire expansions in accordance with present implementations.

FIG. 17 is a side view of an example bracket, in accordance with present implementations.

FIG. 18 is a perspective view of the bracket of FIG. 17, in accordance with present implementations.

FIG. 19 is a top view of example wires, in accordance with present implementations.

FIG. 20 is a top view of example wires, in accordance with present implementations.

FIG. 21 is a top view of example wires, in accordance with present implementations.

FIG. 22 is a top view of example wires, in accordance with present implementations.

FIG. 23 is a top view of example wires where a first wire defines a cavity, in accordance with present implementations.

FIG. 24 is a top view of example wires where a first wire defines a cavity, in accordance with present implementations.

FIG. 25 is a top view of example wires where a first wire defines a cavity, in accordance with present implementations.

FIG. 26 is a top view of example wires where a first wire defines a cavity, in accordance with present implementations.

FIG. 27 is a top view of example wires, in accordance with present implementations.

FIG. 28 is a top view of example wires, in accordance with present implementations.

FIG. 29 is a top view of an example wire including a treatment member, in accordance with present implementations.

FIG. 30 is a close-up view of the wire including a treatment member of FIG. 29, in accordance with present implementations.

FIG. 31 is a top view of an example wire including a plurality of treatment members, in accordance with present implementations.

FIG. 32 is a top view of an example wire including a plurality of treatment members, in accordance with present implementations.

FIG. 33 is a top view of example wires, in accordance with present implementations.

FIG. 34 is a top view of example wires, in accordance with present implementations.

FIG. 35 is a top view of example wires, in accordance with present implementations.

FIG. 36 is a top view of an example wire including a treatment member, in accordance with present implementations.

FIG. 37 is a top view of an example wire including a plurality of treatment members, in accordance with present implementations.

FIG. 38 is a top view of an example wire, in accordance with present implementations.

FIG. 39 is a top view of example wires, in accordance with present implementations.

FIG. 40 is a top view of an example wire including a plurality of treatment members, in accordance with present implementations.

FIG. 41 is a close-up view of the example wire of FIG. 41, in accordance with present implementations.

FIG. 42 is a front view of example brackets, in accordance with present implementations.

FIG. 43 is an example method, in accordance with present implementations.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

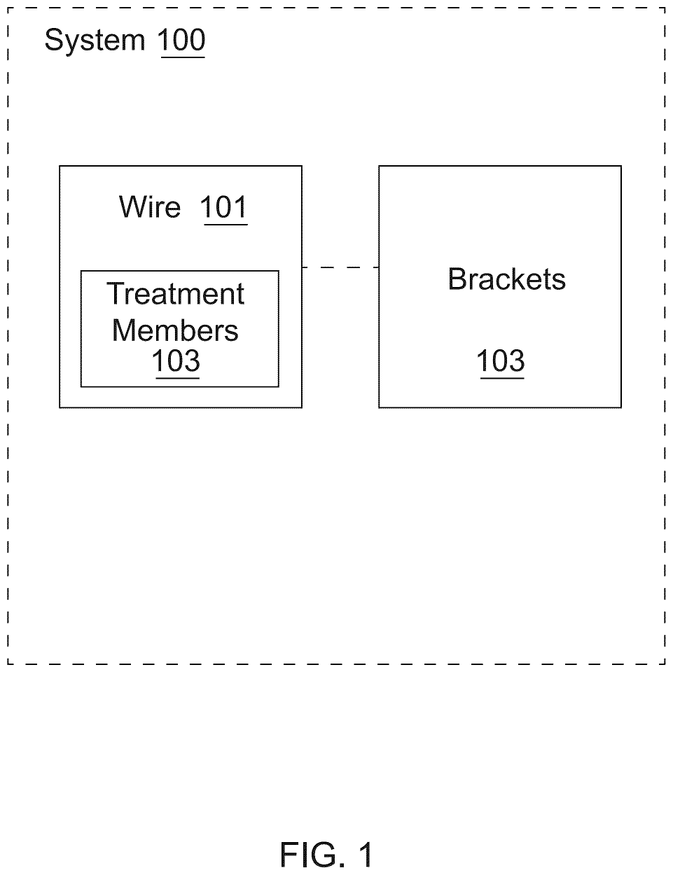

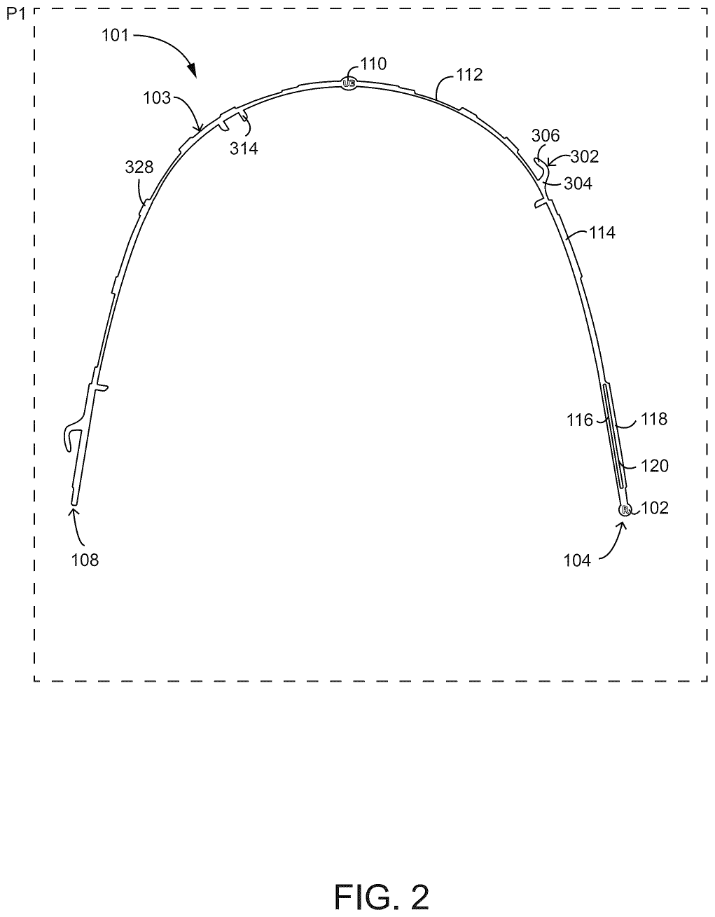

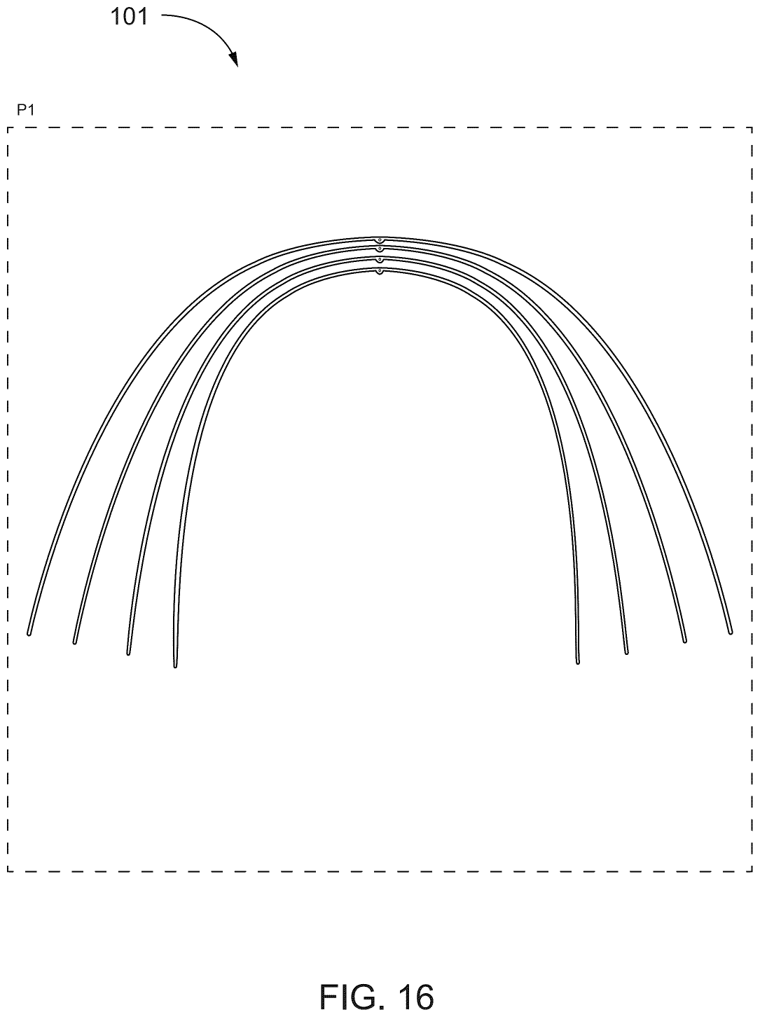

FIG. 1 shows a system 100. The system 100 includes a wire 101. The wire 101 can be arch-shaped as seen in, for example, FIG. 2. The wire 101 can be configured to align with a plurality of teeth of a patient. The wire 101 can be placed on an upper arch (e.g., upper dental arch, maxillary arch, top row of teeth) or lower arch (e.g., lower dental arch, mandibular arch, bottom row of teeth) of the patient. The dental arch can refer to a U-shaped arrangement along the upper and lower jaws where the plurality of teeth are aligned along the dental arch. As shown in FIG. 16, the wire 101 can be expanded (e.g., stretched, bent) to align with the plurality of teeth. For example, a width of the plurality of teeth may be different for various patients. To accommodate variations in the width, the wire 101 can be expanded. The wire 101 can have different diameters and dimensions dependent on the plurality of teeth. For example, the wire 101 can have a circular and/or a rectangular cross section. The diameter of the wire 101 as well as the thickness and/or the width of the wire 101. A greater thickness of the wire 101 can correspond to a greater force imparted on the plurality of teeth. The wire 101 can include a material. The material can be a flexible material. The material can be a flexible, metallic material. The material can be nickel titanium (NiTi). The material can also be stainless steel. The material can be a shape memory alloy.

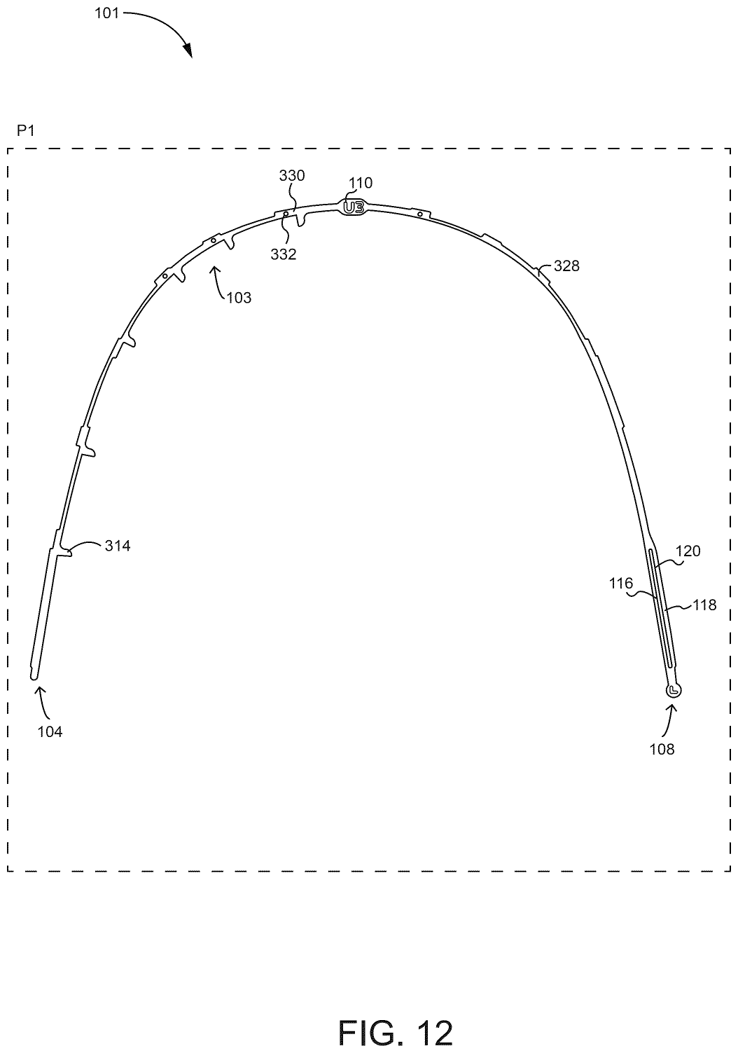

Referring now to FIGS. 2-15, the wire 101 can include a plurality of identifiers (e.g., labels, indicators). The plurality of identifiers can assist, for example, an orthodontist in inserting the wire 101 into a mouth of the patient. For example, the plurality of identifiers can identify the wire 101 as being for the upper arch or the lower arch. The wire 101 can include, as shown in FIGS. 2 and 12, a first identifier 102. The first identifier 102 can be located at a first end 104 of the wire 101. The first end 104 can correspond to a right hand side of the plurality of teeth of the patient. The right hand side of the plurality of teeth can be the right hand side of the patient. For example, the first identifier 102 can correspond to a molar of the plurality of teeth on the right hand side of the patient. The wire can also include a second identifier 106. The second identifier 106 can be located at a second end 108 of the wire 101. The second end 108 can correspond to a left hand side of the plurality of teeth of the patient. For example, the second identifier 106 can correspond to a molar of the plurality of teeth on the left hand side of the patient. The wire 101 can also include a third identifier 110. The third identifier 110 can be located at a midpoint on the wire 101 between the first end 104 and the second end 108. The third identifier 110 can correspond to a center (e.g., midline) of the plurality of teeth of the patient. The midline of the plurality of teeth can be an imaginary vertical line that passes through the central incisors (e.g., two upper, front teeth). For example, the third identifier 110 can be located between central incisors of the plurality of teeth. The third identifier 110 can be used to identify whether the wire 101 corresponds to the upper or lower arch of the patient. The third identifier 110 can also include a number.

The wire 101 can have various thicknesses. For example, the wire 101 can have a first thickness at a first location 112 (e.g., point) and a second thickness at a second location 114. The first thickness and the second thickness can be different. A thickness of the wire 101 can determine an amount of torque applied to the plurality of teeth (e.g., to rotate the teeth). The thickness of the wire 101 can also determine an amount of force and moment applied to the plurality of teeth (e.g., to move the teeth). For example, the first thickness can be greater than the second thickness. In this case, the force applied at the first location 112 is greater than the second location 114. As a result, over time, movement of the tooth at the first location 112 can be greater than movement of the tooth at the second location 114. The thickness of the wire 101 can control movement and alignment of the plurality of teeth. The thickness of the wire 101 can vary (e.g., be different) between any two adjacent teeth or groups of teeth (e.g., three or more teeth).

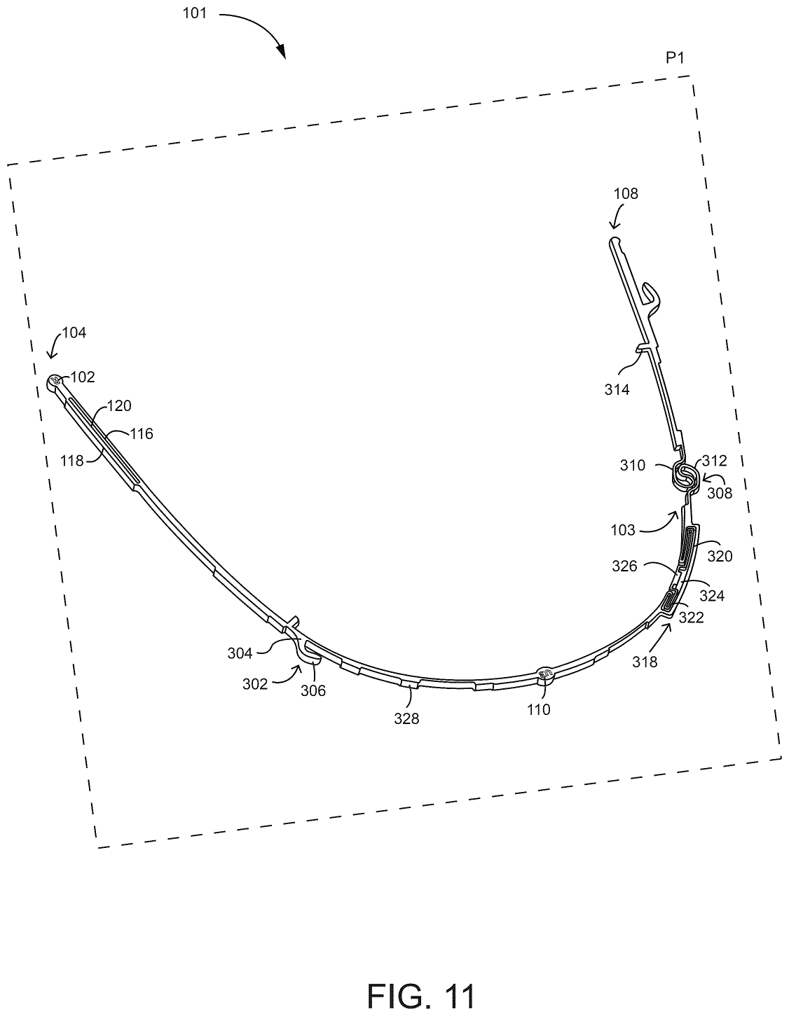

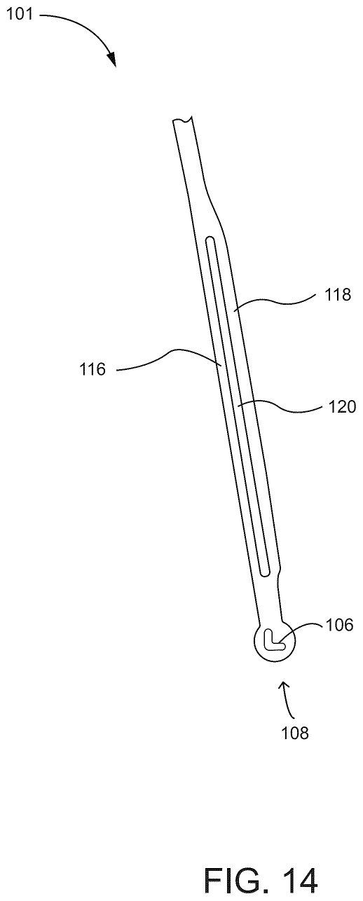

In some implementations, the wire 101 includes a plurality of bars (e.g., segments) as seen in FIG. 14, for example. The wire 101 can include a first bar 116 and a second bar 118. The first bar 116 and the second bar 118 can increase a thickness of the wire 101 to impart a greater, for example, force to the plurality of teeth. The second bar 118 can be parallel to the first bar 116. The wire 101 can also include an aperture 120 located between the first bar 116 and the second bar 118. The first bar 116 and the second bar 118 can be continuous (e.g., integrated) with the wire 101. The first bar 116 and the second bar 118 can be located closer to the second identifier 106 than the third identifier 110 as seen in, for example, FIG. 11. The first bar 116 and the second bar 118 can also align teeth. For example, the second bar 118 can extend to a misaligned tooth while the first bar 116 stabilizes the wire 101 to ensure that an extension of the second bar 118 does not move the wire 101. In some implementations, the first bar 116 is on the first plane P1 while the second bar 118 is on a second plane parallel to the first plane P1.

Referring further to FIG. 1, the wire 101 can include a plurality of treatment members 103 (e.g., orthodontic accessories, attachments) as described further herein. The plurality of treatment members 103 can extend from and/or be continuous with the wire 101. The plurality of treatment members 103 can be configured to align the plurality of teeth with the wire 101. The wire 101, as manufactured and before being deployed, can be located on or extend along a plane P1. The wire 101, as manufactured and before being deployed, is formed from a sheet material defined by two parallel planes. The plurality of treatment members 103 can also be located on the plane P1. The plane P1 can be an imaginary plane. The plurality of treatment members 103 can be configured to align the plurality of teeth with the wire 101. The plurality of treatment members 103 can be continuous (e.g., seamless) with the wire 101. The plurality of treatment members 103 can extend from the wire 101 on the plane P1. The wire 101 and the plurality of treatment members 103 can be a monolithic apparatus (e.g., integrated, unitary structure). The monolithic apparatus can be formed from a single sheet of the material, where the sheet is defined by two planes P1 and a thickness in the z-direction, the thickness being the distance between the two planes P1. For example, the wire 101 and the plurality of treatment members 103 can be laser cut, water jet cut, stamped, or electric discharge machined from the single sheet. In various implementations, the wire 101 and the plurality of treatment members 103 can also be formed from investment casting, additive manufacturing (3D printing), or shape forming, among others. The wire 101 and the treatment members 103 may have the same thickness in the z-direction as they are formed from a sheet having a uniform thickness in the z-direction, and may have different thickness or width extending along a plane P1 (defined by the x-y directions). The thickness in the z-direction being perpendicular to the plane P1 defined in the x-y directions. A first surface of the monolithic apparatus can lie on a first plane and an opposite second surface of the monolithic apparatus can lie on a second plane, parallel to the first plane. The thickness in the z-direction is a distance between the first plane and the second plane. Either the first or second plane can be referred to as the plane P1.

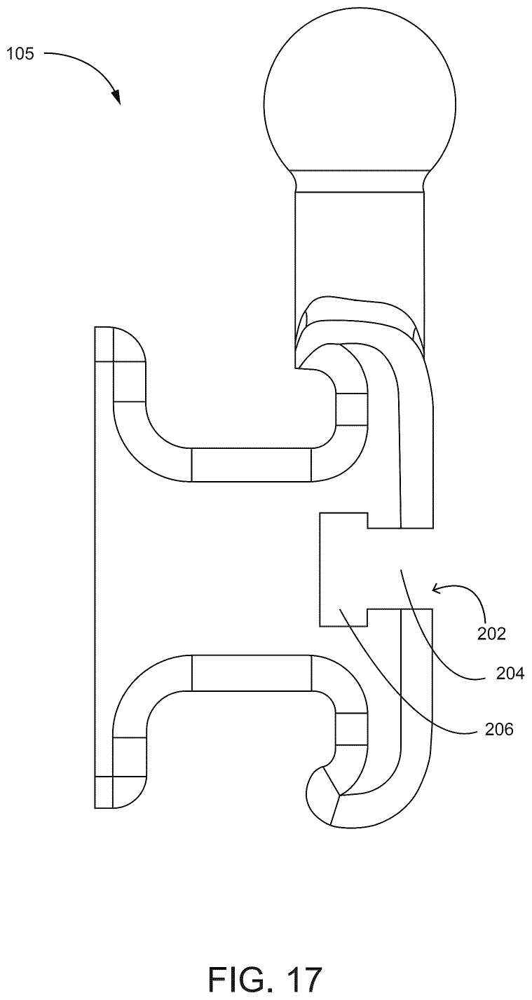

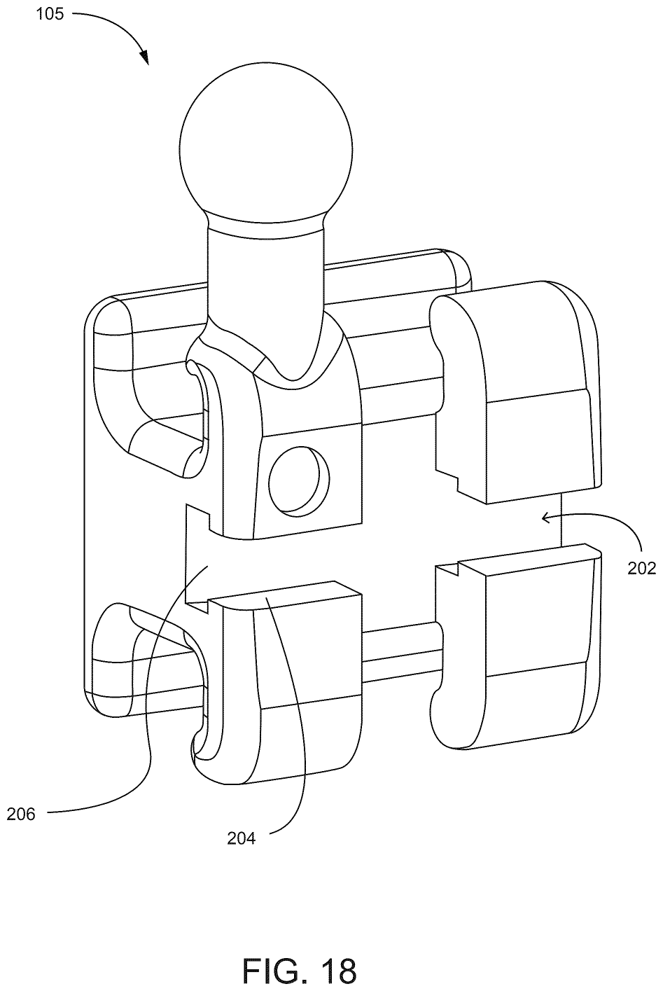

The system 100 can further include a plurality of brackets 105, seen in FIGS. 17-18. The plurality of brackets 105 can be located on the plurality of teeth. Each of the plurality of brackets 105 can be located on one of the plurality of teeth. The plurality of brackets 105 can be coupled to the plurality of teeth. The plurality of brackets 105 can be coupled to the plurality of teeth via an adhesive. The wire 101 can be coupled to the plurality of brackets 105. In some implementations, at least one of the plurality of treatment members 103 can be coupled to at least one of the plurality of brackets 105. The wire 101 can be configured to align with and be coupled to the plurality of brackets 105. For example, the wire 101 can be expanded to align with the plurality of brackets 105.

The plurality of brackets 105 includes a plurality of slots 202 (e.g., receiving space) as seen in FIGS. 17-18. The plurality of slots 202 can be rectangular shaped. The plurality of slots 202 can have a width and a height. The height can range from 0.018 to 0.022 inches, inclusive. The width can range between inches, inclusive. In some implementations, the height is greater than 0.022 inches or less than 0.018 inches. Each of the plurality of brackets 105 can include at least one of the plurality of slots 202. The plurality of slots 202 can include a first portion 204 and a second portion 206. The second portion 206 can extend from the first portion 204. The first portion 204 can have a first height while the second portion 206 can have a second height. The second height can be greater than the first height. The plurality of slots 202 can hold the wire 101. The plurality of slots 202 can hold various sizes, diameters, and/or thicknesses of the wire 101. O-rings (e.g., elastic rings) and/or the metallic ligatures (e.g., wires) may maintain (e.g., secure) the wire 101 within the plurality of slots 202. In some implementations, the plurality of brackets 105 can tighten to secure the wire 101 within the plurality of slots 202. The first portion 204 and the second portion 206 can correspond to different thicknesses or widths of the wire 101. For example, responsive to the second thickness being greater than the first thickness, a portion of the wire 101 at the second location 114 is located within the second portion 206 while a portion of the wire 101 at the first location 112 is located within the first portion 204.

In some embodiments, the plurality of slots 202 are angled. For example, the plurality of slots 202 can be centered on a plane as seen in FIG. 17. The plurality of slots 202 can be angled relative to the plan. Angling the plurality of slots 202 can allow torque to be imparted on the tooth of an angled slot 202 to rotate the tooth. The plurality of slots 202 can have an angle ranging between 5 to 70 degrees, inclusive.

The thickness of the wire 101 can vary between the plurality of brackets 105. For example, the first location 112 can be located within the plurality of slots 202 while the second location 114 can be located on the wire 101 between the plurality of brackets 105. The first thickness at the first location 112 can be different than the second thickness at the second location 114. The first thickness can determine an amount of torque applied to the tooth. The second thickness can determine an amount of force and moment applied to the teeth. A portion of the wire 101 between the plurality of brackets 105 (e.g., interbracket segments, the second location 114, corresponding to the second thickness) can include springs and/or apertures to adjust the force and moment applied to the teeth.

In some implementations, the plurality of slots 202 does not include the first portion 204 and the second portion 206. In this case, the plurality of slots 202 can have a rectangular shape. The plurality of slots 202 can have a height. The height can range from 0.015 to 0.025 inches, inclusive. For example, the plurality of slots 202 can have a height of 0.018 inches. The height of the plurality of slots 202 can correspond to a thickness of the wire 101.

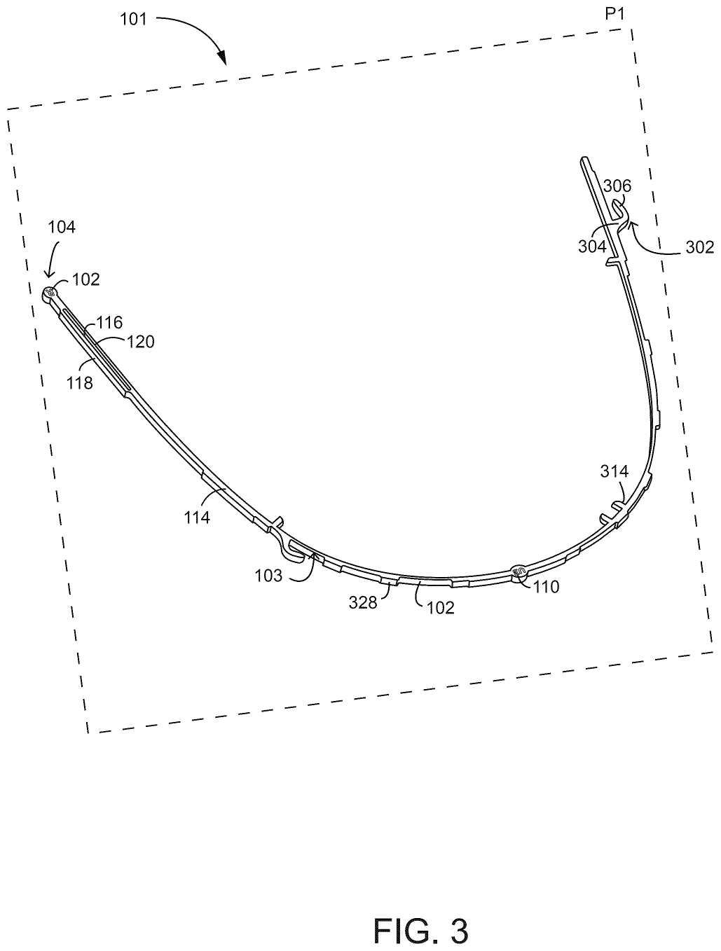

Referring now to FIGS. 2-3, the plurality of treatment members 103 can include one or more hooks 302 (e.g., elastic attachments). The hook 302 can extend from (e.g., be integrated with) the wire 101 on the plane P1. The hook 302 can extend from the wire 101 along the plane P1. For example, a first surface of the wire 101 and the hook 302 can lie on a first plane and a second surface of the wire 101 and the hook 302 can lie on a second plane parallel to the first plane. Either the first plane or the second plane can be the plane P1. The hook 302 can be used to connect elastic (e.g., rubber) bands. The elastic bands can be used to connect upper arches (e.g., the plurality of teeth on an upper jaw) and lower arches (e.g., the plurality of teeth on a lower jaw) to correct overbites, underbites, and/or crossbites. For example, the hook 302 may be placed on both the upper arch and the lower arch and the elastic band may stretch from the upper arch to the lower arch. The elastic bands can apply force to move the teeth and jaw into proper alignment. The hook 302 can be used to engage the elastic bands at mesial (e.g., side of tooth that faces the midline), distal (e.g., a side of the tooth that faces away from the midline), or both the mesial and distal sides. The hook 302 placed on the mesial side may guide teeth to the midline while the hook 302 placed on the distal side may guide the teeth toward the molars. The hook 302 placed on both the mesial and distal sides may allow for movement in multiple directions.

The hook 302, as seen in FIGS. 2-3, can include a first portion 304 (e.g., segment, part) extending from the wire 101. The first portion 304 can extend at a first angle between 30 to 80 degrees, inclusive, relative to the wire 101. The first portion 304 can be located on the plane P1. The hook 302 can include a second portion 306 extending from the first portion 304 at a second angle between 30 to 90 degrees, inclusive, relative to the first portion 304. The second portion 306 can be on the plane P1. A length and a width of the first portion 304 can be equal to a length and a width of the second portion 306. In some implementations, at least one of a length and a width of the first portion 304 is greater than the length and/or the width of the second portion 306. In some implementations, at least one of a length and a width of the first portion 304 is less than the length and/or the width of the second portion 306. A thickness of the first portion 304 can be different from a thickness of the second portion 306. In some implementations, the hook 302 can be bent out of the plane P1.

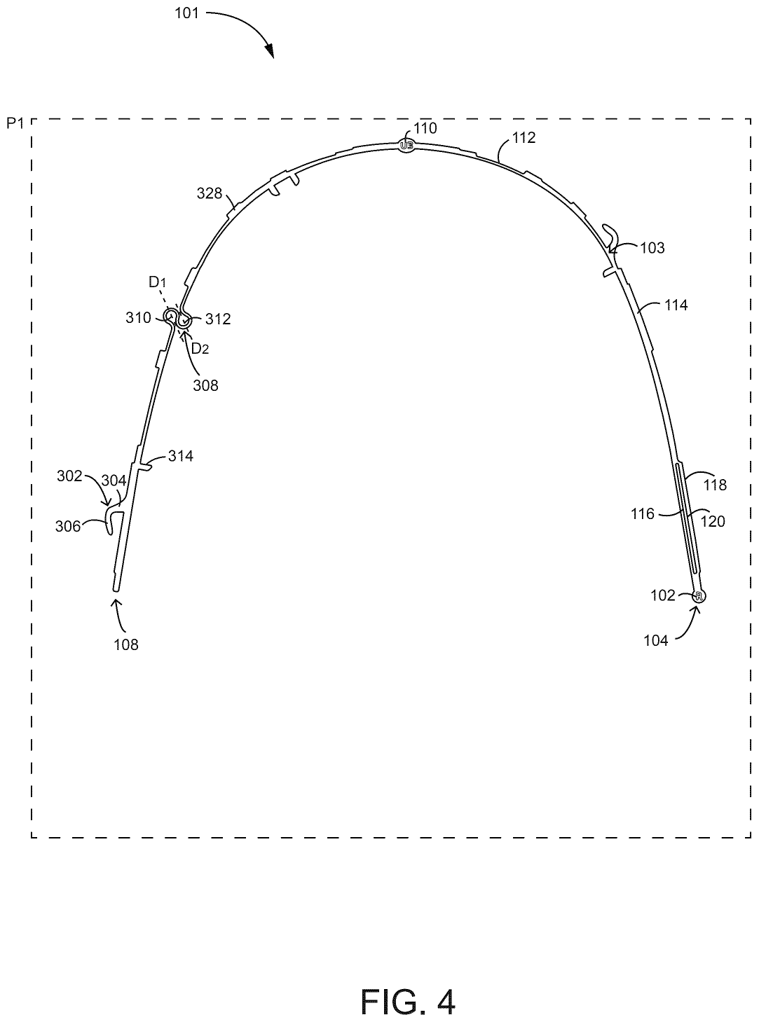

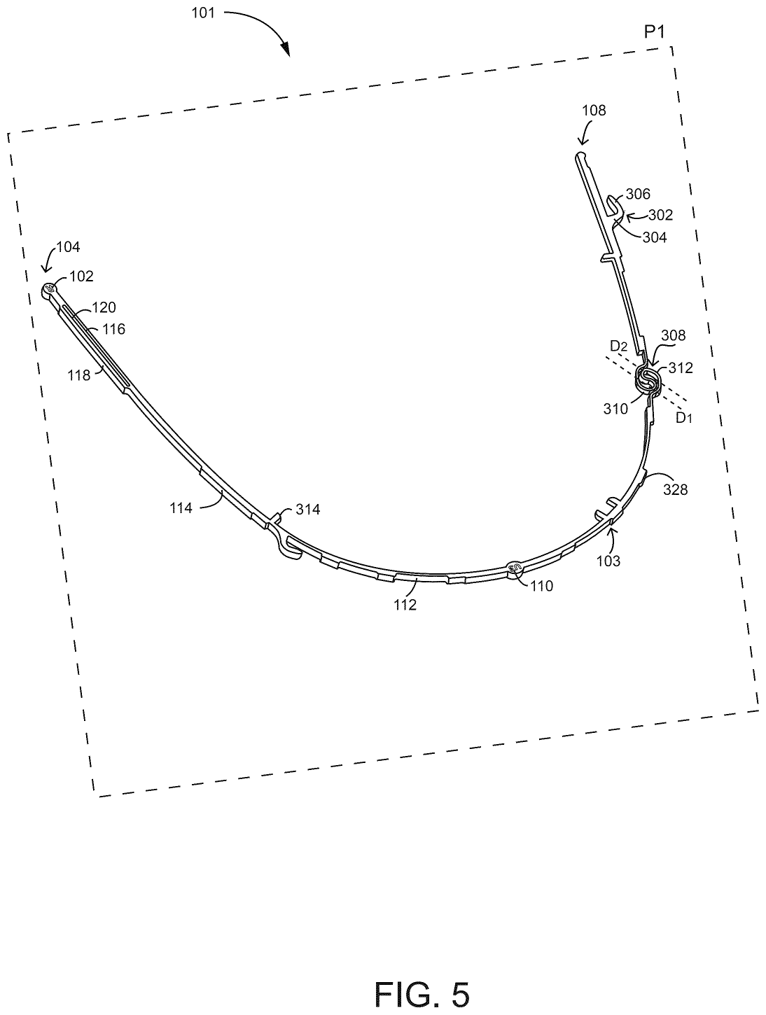

Referring now to FIGS. 4-5, the plurality of treatment members 103 can include one or more loops 308 (e.g., springs). The loop 308 can be continuous with (e.g., integrated with) the wire 101 and on the plane P1. For example, a first surface of the wire 101 and the loop 308 can lie on a first plane and a second surface of the wire 101 and the loop 308 can lie on a second plane parallel to the first plane. Either the first plane or the second plane can be the plane P1. The loop 308 can decrease or increase a space (e.g., gap) between adjacent teeth. The loop 308 can also maintain the space between adjacent teeth. The loop 308 can be used to move teeth in a direction, such as the mesial direction.

The loop 308 can include a first curved portion 310 (e.g., curved segment, rounded portion). The first curved portion 310 can extend from the wire 101 in a first direction D1 on the plane P1. The loop 308 can include a second curved portion 312 extending in a second direction D2. The second direction D2 can be opposite the first direction D1. Both the first curved portion 310 and the second curved portion 312 can extend from the wire 101. The second curved portion 312 can extend from (e.g., be continuous with) the first curved portion 310. In some implementations, the second direction D2 is angled relative to the first direction D1.

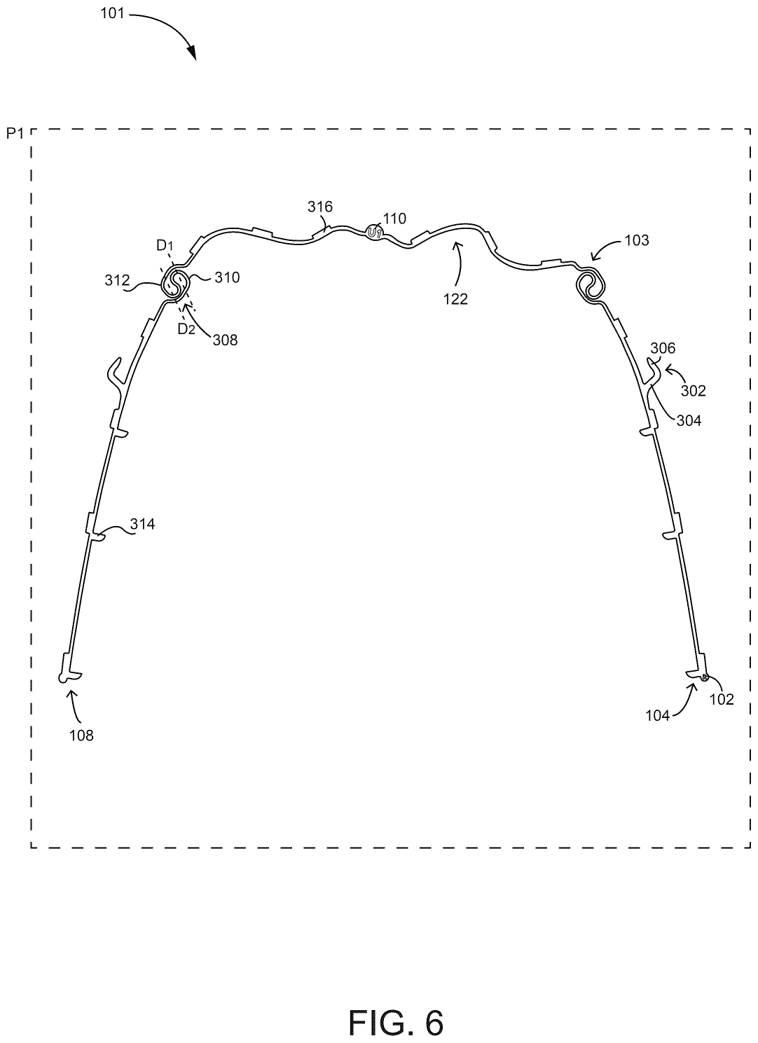

Referring now to FIGS. 6-9, the plurality of treatment members 103 can include one or more first protrusions 314 (e.g., extensions, projections) and one or more second protrusions 316. The first protrusions 314 and the second protrusions 316 can be on the plane P1 and prevent round tripping (e.g., teeth moving back and forth). The first protrusions 314 and the second protrusions 316 can prevent the plurality of teeth from moving from a first position, to a second position, and back to the first position. The first protrusions 314 and the second protrusions 316 can mitigate movement of the plurality of teeth. The first protrusions 314 and the second protrusions 316 can have a thickness equal to the wire 101. The first protrusions 314 and the second protrusions 316 can have a thickness different from the wire 101.

The first protrusions 314 can extend from the wire 101 on the plane P1. The first protrusions 314 can face the plurality of teeth. For example, the first protrusion 314 are located on a lingual side of the plurality of teeth (e.g., side of teeth facing the tongue). The second protrusions 316 can extend from the wire 101 on the plane P1. The second protrusions 316 can face away from the plurality of teeth. For example, the second protrusions 316 are located on a buccal side (e.g., side of teeth facing inside of cheeks) of the plurality of teeth. The first protrusions 314 and the second protrusions 316 can face opposite directions. In some implementations, the first protrusions 314 and the second protrusions 316 are angled relative to the wire 101. The first protrusions 314 can be in contact with the plurality of teeth. The first protrusions 314 can be located in the space between adjacent teeth. The second protrusions 316 can be located within the plurality of slots 202. The second protrusions 316 can have a thickness equal to or less than the height of the plurality of slots 202. As seen in, for example, FIG. 6, the second protrusions 316 may be located closer to the third identifier 110 while the first protrusions 314 are located closer to the first identifier 102 and/or the second identifier 106.

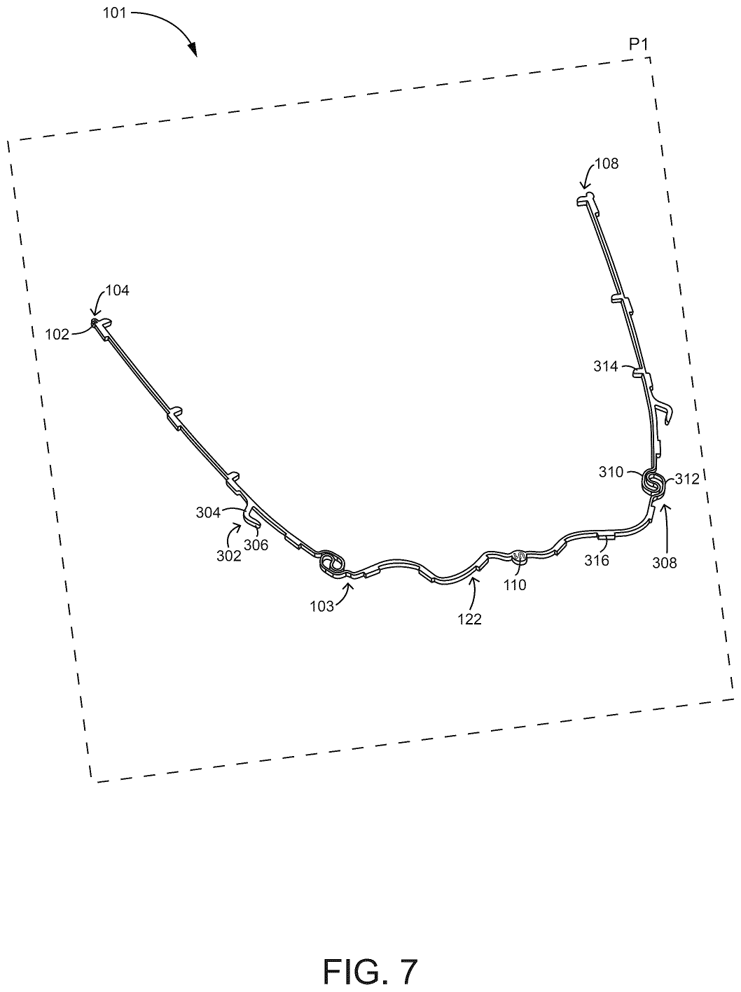

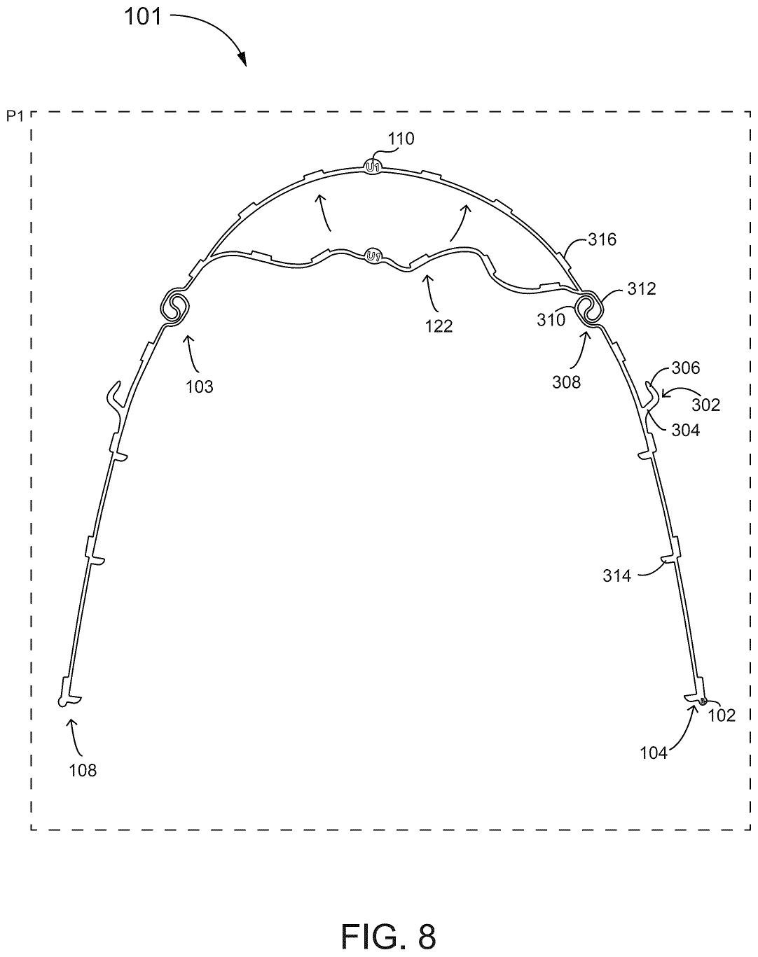

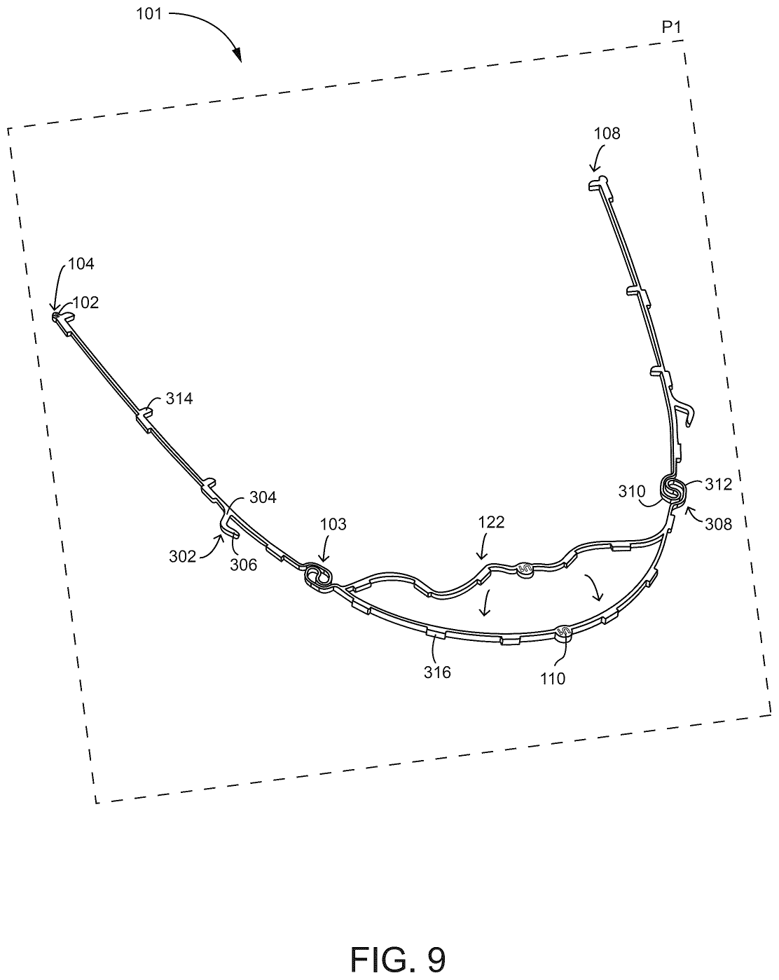

In some implementations, as seen in FIGS. 6-7, to prevent round tripping, the wire 101 can include one or more curved segments (e.g., curved portions, rounded segments) 122. The wire 101 can curved based on a degree of misalignment of the plurality of teeth. For example, a degree at which the curved segments 122 curve can increase responsive to the plurality of teeth being more misaligned from the dental arch. The curved segments 122 can align with the plurality of teeth. For example, a tooth, such as a premolar, may be extracted prior to aligning anterior (e.g., back of mouth) teeth (e.g., molars). In this case, the wire 101 can be placed on the plurality of brackets 105 to maintain a position of the teeth (e.g., including the anterior teeth). This can allow for an extraction space (e.g., where the premolar was located) to close without round tripping of the anterior teeth. The wire 101 may be placed passively (e.g., not tightened within the plurality of slots 202) in the plurality of brackets 105 to prevent round tripping. In this case, the wire 101 may not enact a force on the plurality of teeth. The first protrusions 314 can provide a larger area (e.g., compared to the wire 101) for the plurality of brackets 105 to passively hold. For example, the first protrusions 314 may have a width equal to the width of the plurality of slots 202 while the wire 101 has a width less than the width of the plurality of slots 202. The first protrusions 314 can have a thickness equal to or less than the height of the plurality of slots 202. The curved segments 122 may align with the plurality of teeth to maintain a position of the plurality of teeth. Once the extraction space has closed, the wire 101 can be straightened (e.g., the curved segments 122 removed) as seen in FIGS. 8-9. The wire 101 being straightened can enable the wire 101 to provide force to the plurality of teeth.

In some implementations, the first protrusions 314 can move the teeth in a mesial or distal direction or prevent mesial or distal movement. The first protrusions 314 can be smooth. The first protrusions 314 can be located on the mesial, distal, or both sides of the plurality of brackets 105. The first protrusions 314 can contact the plurality of brackets 105 to move the teeth in a direction responsive to the first protrusion 314 being located on the mesial or distal side. The first protrusions 314 can also contact the plurality of brackets 105 to prevent movement of the teeth responsive to the first protrusion being located on both the mesial and distal side, as seen in, for example, FIG. 4.

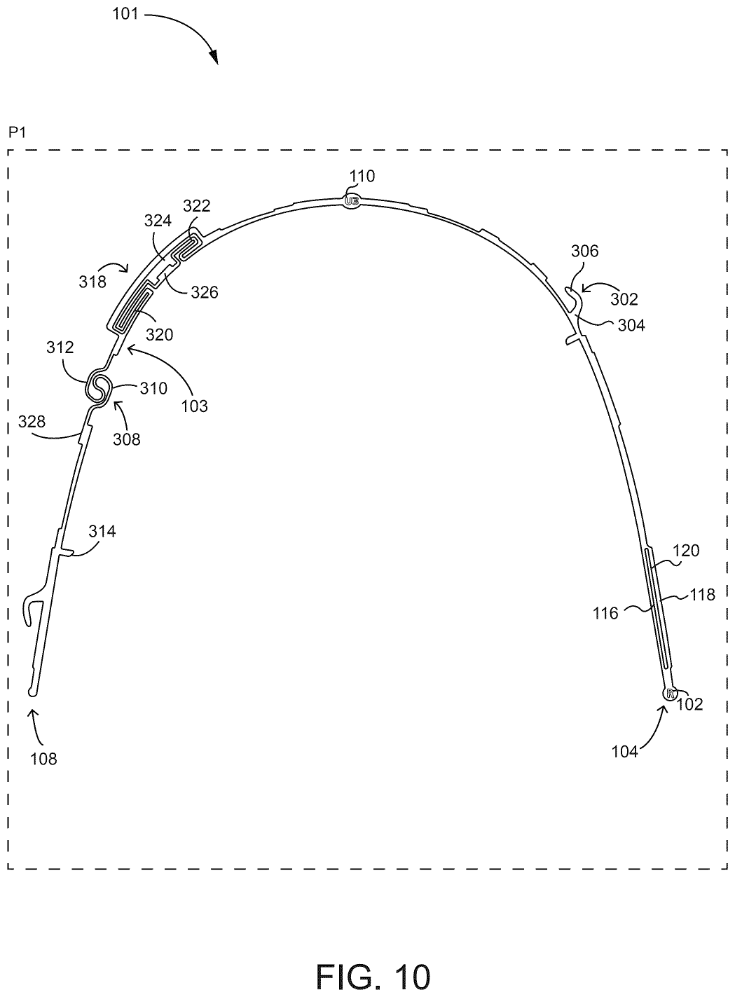

Referring now to FIGS. 10-11, the plurality of treatment members 103 can include one or more aligners 318 (e.g., piggyback, supplemental wiring, tandem). The aligner 318 can align teeth such as high buccal canines (e.g., canine positioned above the dental arch). The aligner 318 can pull (e.g., move) teeth to the dental arch and align the teeth with the wire 101. To do this, the aligner 318 can include one or more segments. A first segment (e.g., stabilizing part) can be continuous with the wire 101 while a second segment (e.g., moving part) can connect to a misaligned tooth to guide the misaligned tooth to the dental arch and towards the wire 101. The first segment and the second segment can ensure that a stability of the wire 101 is maintained (e.g., wire 101 does not move) while moving the misaligned tooth. The second segment can connect to the misaligned tooth via the bracket 105 on the misaligned tooth.

The aligner 318 can be continuous with the wire 101. The aligner 318, as shown in FIGS. 10-11 can include a first curved portion 320 on the plane P1. The aligner 318 can also include a second curved portion 322. The first curved portion 320 and the second curved portion 322 can be the first segment. The second curved portion 322 can be continuous with the first curved portion 320 on the plane P1. The first curved portion 320 and the second curved portion 322 can have a serpentine shape. The first curved portion 320 and the second curved portion 322 can define a receiving space 324 (e.g., aperture). The receiving space 324 can include a protrusion 326. The receiving space 324 can be the second segment. The receiving space 324 can be moved to the misaligned tooth and the protrusions 326 can be placed within the slot 202 of the bracket 105 on the misaligned tooth. An O-ring, for example, can secure the protrusion 326 within the slot 202. The receiving space 324 can receive at least one of the plurality of teeth. The first curved portion 320 and the second curved portion 322 can be configured to extend to the at least one of the plurality of teeth (e. g., the misaligned tooth, high buccal canine). The first curved portion 320 and the second curved portion 322 can maintain the stability of the wire 101 while extending to allow the protrusion 326 to be attached to the bracket 105 of the misaligned tooth. To attach to the misaligned tooth, the aligner 318 can be extended out of the plane P1. The first curved portion 320 and the second curved portion 322 can also increase a gap between two of the teeth to allow the aligner 318 to pull the misaligned tooth to be positioned between the two of the teeth.

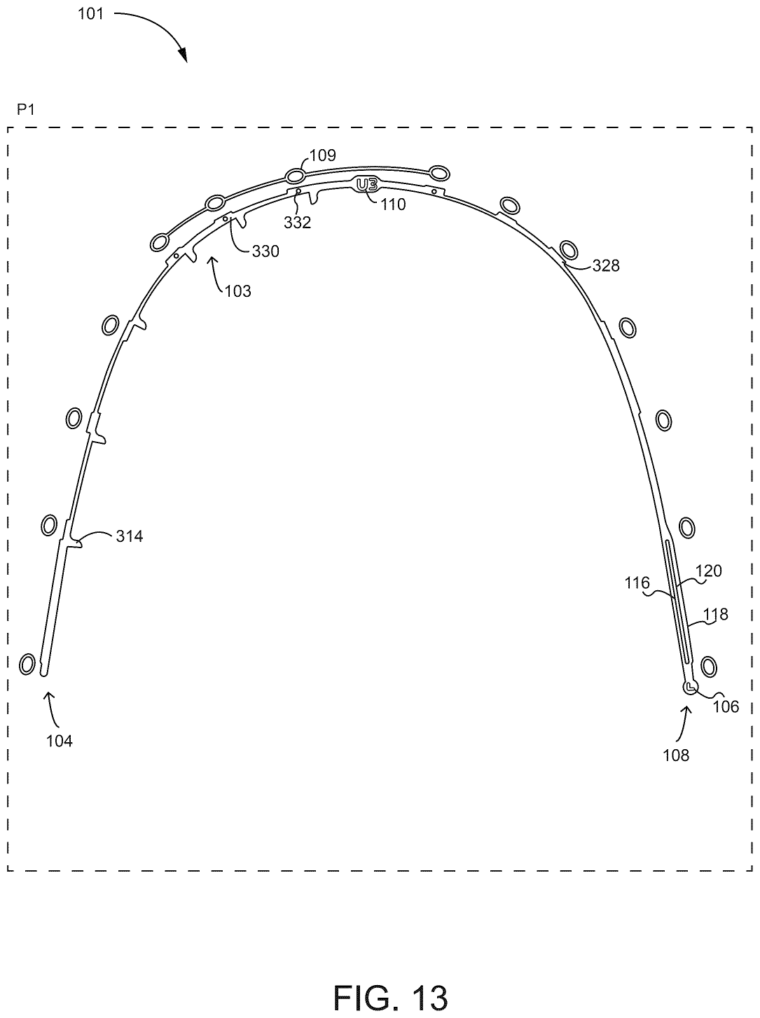

Referring now to FIGS. 12-13, the plurality of treatment members 103 can include one or more first markers 328 and one or more second markers 330. The first markers 328 and the second markers 330 can align with the plurality of brackets 105. The first markers 328 and the second markers 330 can signify placement of O-rings 107 or power chains 109 on the plurality of brackets 105. For example, the first markers 328 can indicate to, for example, an orthodontist, to place O-rings 107 on the plurality of brackets 105 aligned with the first markers 328. The second markers 330 can indicate to place power chains 109 on the plurality of brackets 105 aligned with the second markers 330. The first markers 328 can be continuous with the wire 101. In some implementations, the first markers 328 are thicker than the wire 101. In some implementations the first markers 328 extend from the wire 101 and face away from the plurality of teeth. The second markers 330 can extend from the wire 101 and face away from the plurality of teeth. The second markers 330 can include apertures 332 to signify placement of the power chain 109.

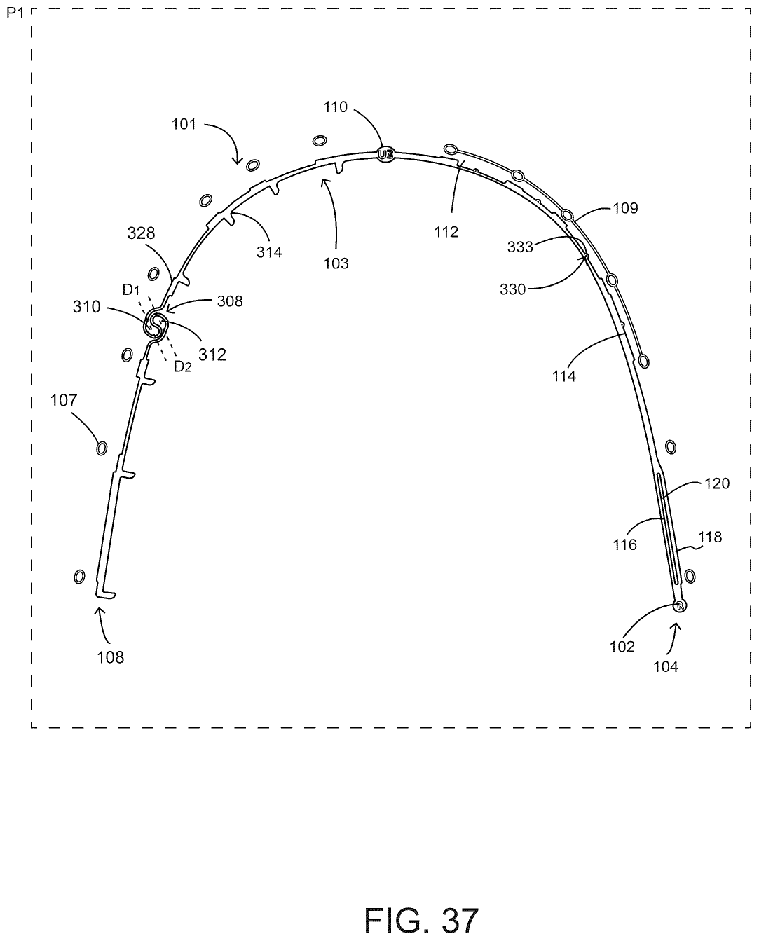

In some embodiments, as seen in the second markers 330 do not include apertures 332 and instead, include protrusions 333 as seen in FIG. 37. The protrusions 333 can replace the apertures 332 as the second markers 330. The protrusions 333 may be in contact with the power chain 109. The protrusions 333 may be located along the wire between the first markers 328. For example, to signify placement of the O-rings 107, the wire 101 may not include the second markers 330 and only include the first markers 328. To signify placement of the power chains 109, the wire 101 may include both the second markers 330 and the first markers 328. The first markers 328 may be aligned with the plurality of brackets 105 for the power chain 109 and/or the O-rings 107 to be in contact with while the second markers 330 are located between the first markers 328 to signify placement of the power chain 109.

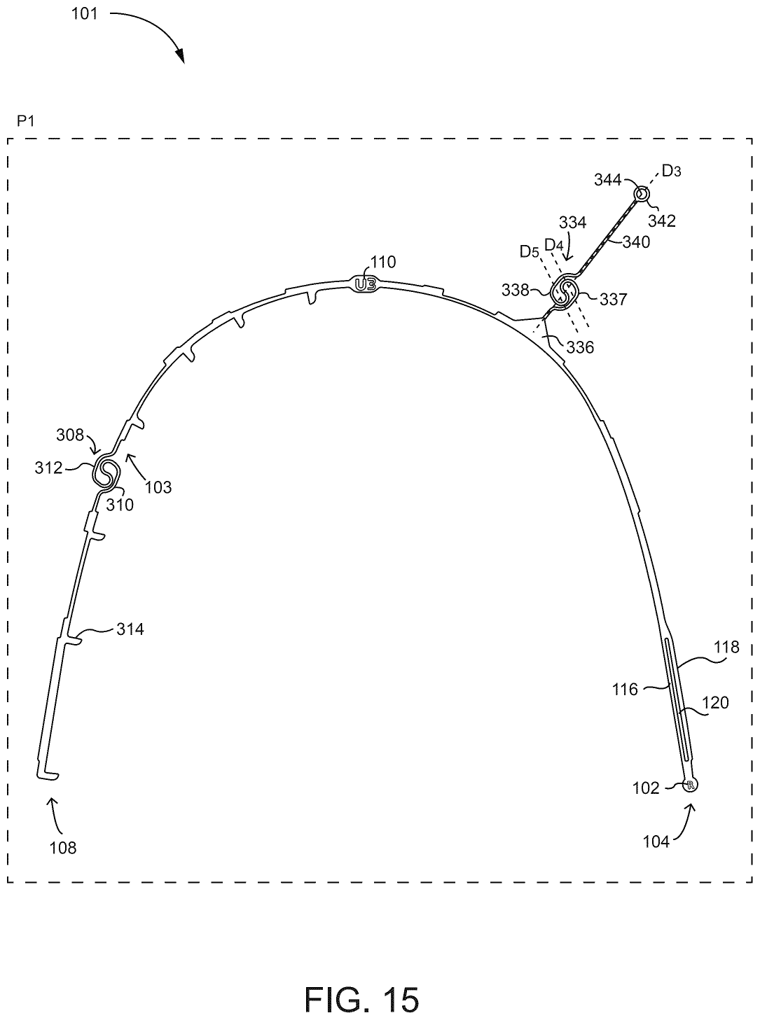

Referring now to FIG. 15, the plurality of treatment members 103 can include one or more links 334 (e.g., connector). Canine teeth within the plurality of teeth can be impacted (e.g., fail to properly erupt, remain within a gum of the mouth of the patient). The canine tooth can be aligned with the dental arch using the link 334. The link 334 can pull (e.g., move) the canine tooth to align with the plurality of teeth. The link 334 can move the canine tooth towards the upper arch to align with the wire 101. The link 334 can attach to the bracket 105 on the canine tooth to move the canine tooth to the upper arch.

The link 334 can include a protrusion 336 extending from the wire 101 in a third direction D3 on the plane P1. The protrusion 336 can maintain the stability of the wire 101 while the link 334 is enacting force on the canine tooth to align the canine tooth. The protrusion 336 can have a triangle shape. The link 334 can include a first curved portion 337 extending from the protrusion 336 in a fourth direction D4 on the plane P1. The link 334 can also include a second curved portion 338 extending from the first curved portion 337 in a fifth direction D5. The fifth direction D5 can be opposite the fourth direction D4. In some implementations, the link 334 can include the loop 308. The link 334 can further include a straight portion 340 (e.g., segment) extending from the second curved portion 338. The straight portion 340 can extend in the third direction D3. The link 334 can also include a circular portion 342 extending from the straight portion 340. The circular portion 342 can connect to at least one of the plurality of brackets 105. The circular portion 342 can extend around an aperture 344. The aperture 344 can be coupled to the bracket 105 located on the canine. For example, the circular portion 342 can extend around the bracket 105 or be located within the slot 202 of the bracket 105. The link 334 can be bent out of the plane P1 to extend to the canine. The first curved portion 337 and the second curved portion 338 can provide force to close a distance (e.g., space) between the wire 101 and the canine.

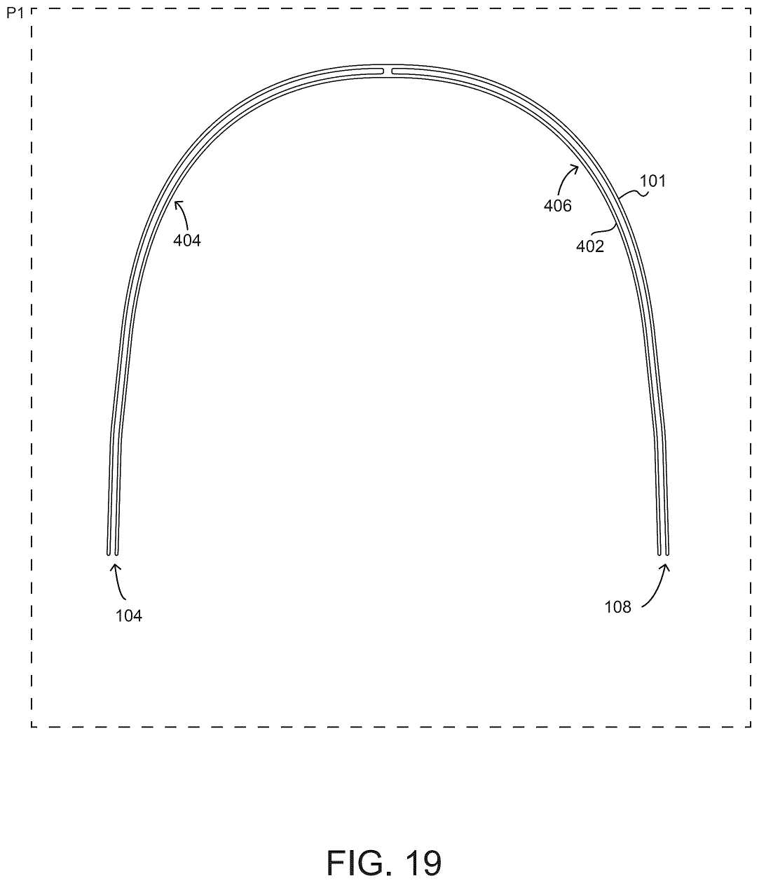

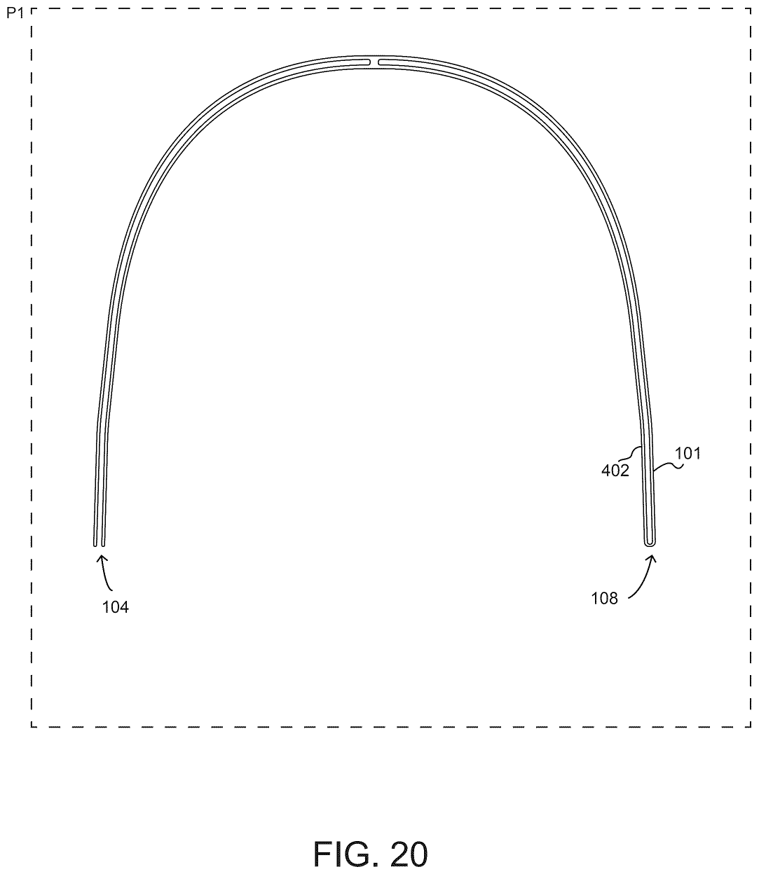

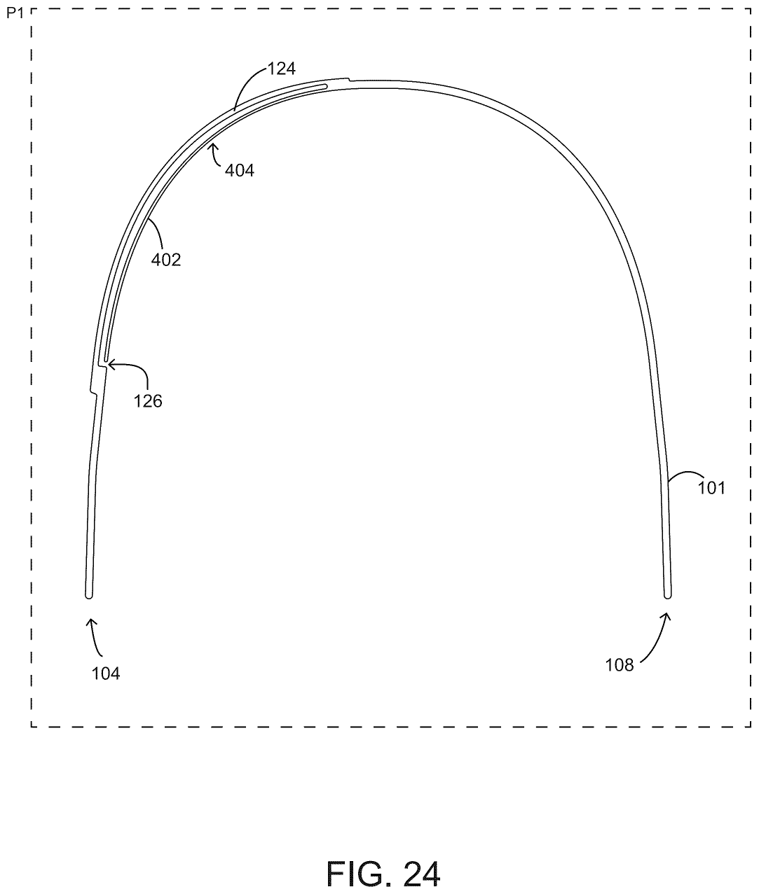

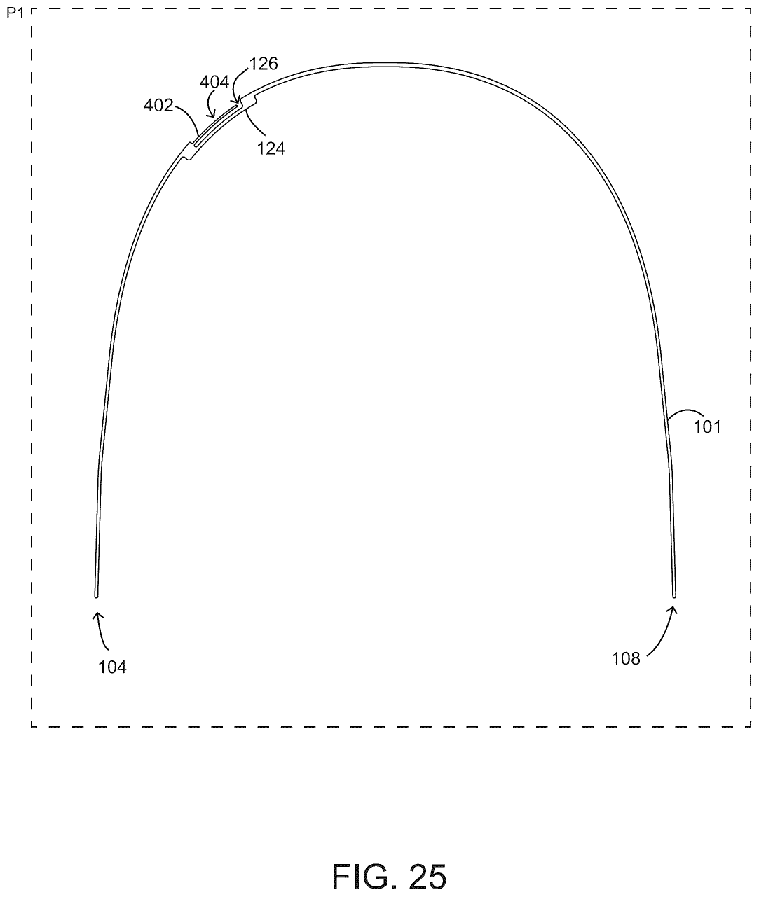

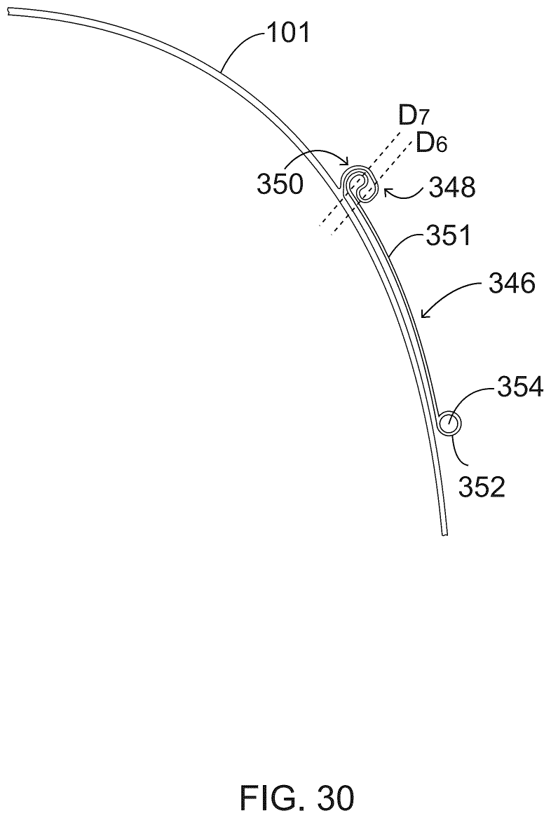

In some embodiments, the wire 101 is a first wire 101. As seen in FIGS. 19-35, the system 100 can include a second wire 402. The second wire 402 can also be arched-shaped. The second wire 402 can extend along the plane P1. The second wire 402 can include the material. The material can be a flexible material. The material can be a flexible, metallic material. The material can be nickel titanium (NiTi). The material can also be stainless steel. The material can be a shape memory alloy. The first wire 101 and the second wire 402 can be coupled. For example, the first wire 101 and the second wire 402 can be coupled at the midpoint (e.g., middle, center) of the first wire 101 and the second wire 402 as seen in FIG. 19. The first wire 101 and the second wire 402 can also be coupled at any point along the first wire 101. The first wire 101 and the second wire 402 can also be coupled at the first end 104 and/or the second end 108 of the first wire 101 as seen in, for example, FIG. 20. The first wire 101 can be a stabilizing wire and the second wire 402 can align teeth to the first wire 101. For example, the first wire 101 can be coupled to teeth within the dental arch while the second wire 402 is coupled to the teeth within the dental arch and teeth not in the dental arch (e.g., misaligned teeth). The first wire 101 can mitigate movement of the teeth within the dental arch while the second wire 402 moves teeth towards the dental arch. In this case, the first wire 101 can be thicker than the second wire 402. In some embodiments, the second wire 402 is the stabilizing wire and the first wire 101 aligns teeth to the second wire 402.

In some embodiments, the second wire 402 is in contact with the bracket 105. In some embodiments, the second wire 402 is in contact with the plurality of teeth and not in contact with the bracket 105. In some embodiments, the second wire 402 has a thickness equal to a thickness of the first wire 101. In some embodiments, the thickness of the second wire 402 is different than the thickness of the first wire 101.

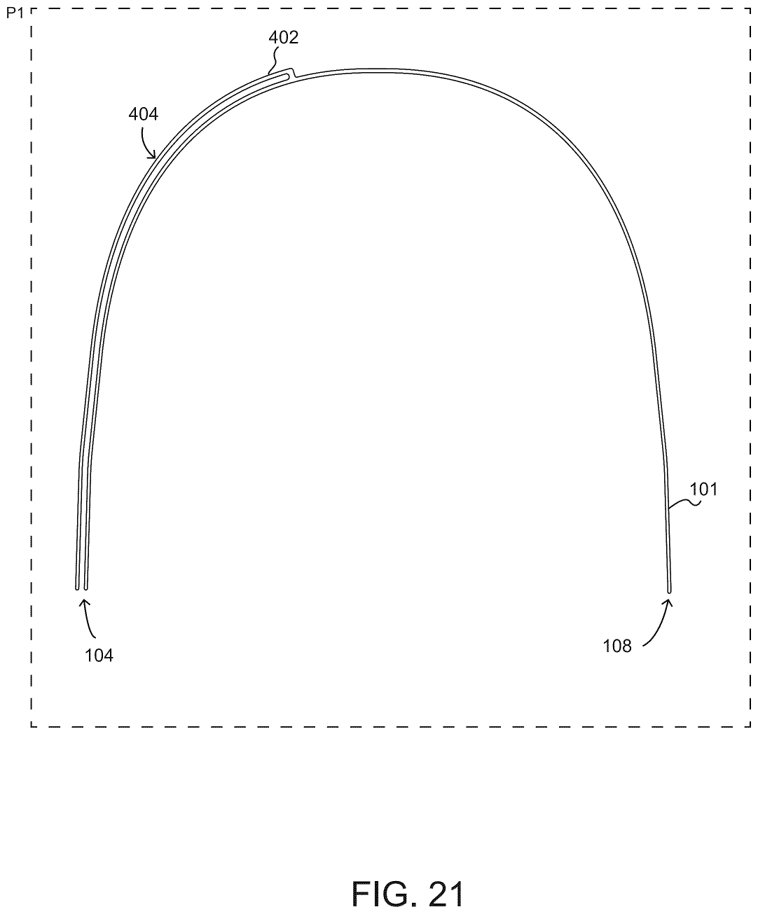

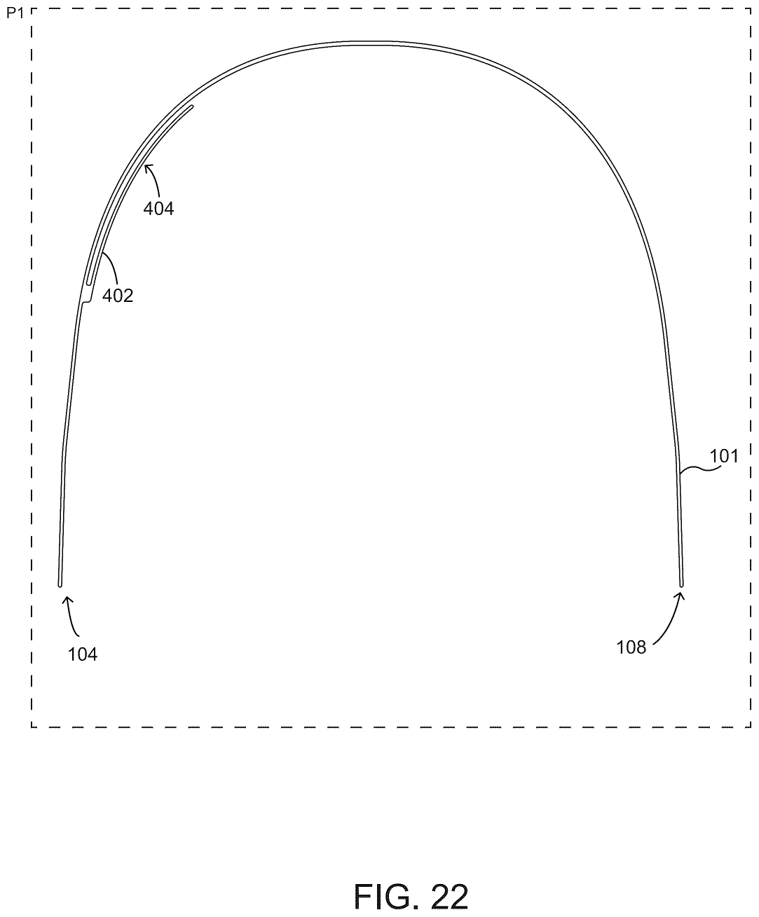

In some embodiments, the second wire 402 includes a first portion 404 (e.g., part, segment) and a second portion 406. The first portion 404 can correspond to a length of the first wire 101 from the first end 104 to the midpoint. The second portion 406 can correspond to a length of the first wire 101 from the midpoint to the second end 108. The first portion 404 can be coupled to the first wire 101. The first portion 404 can be coupled to the first wire 101 between the first end 104 and the midpoint and extend towards the first end 104, as seen in FIG. 21. The first portion 404 can also extend towards the midpoint, as seen in FIG. 22. The first portion 404 can have a length less than the length of the first wire 101 from the first end 104 to the midpoint. The first portion 404 can have a length equal to the length of the first wire 101 from the first end 104 to the midpoint. In some embodiments, the first portion 404 extends on a side of the first wire 101 in contact with the plurality of teeth. In some embodiments, the first portion 404 extends on a side of the first wire 101 not in contact with the plurality of teeth.

In some embodiments, the second portion 406 is coupled to the first wire 101. The second portion 406 can be coupled to the first wire 101 between the second end 108 and the midpoint and extend towards the second end 108. The second portion 406 can also extend towards the midpoint. The second portion 406 can have a length less than the length of the first wire 101 from the second end 108 to the midpoint. The second portion 406 can have a length equal to the length of the first wire 101 from the second end 108 to the midpoint. In some embodiments, the second portion 406 extends on a side of the first wire 101 in contact with the plurality of teeth. In some embodiments, the second portion 406 extends on a side of the first wire 101 not in contact with the plurality of teeth.

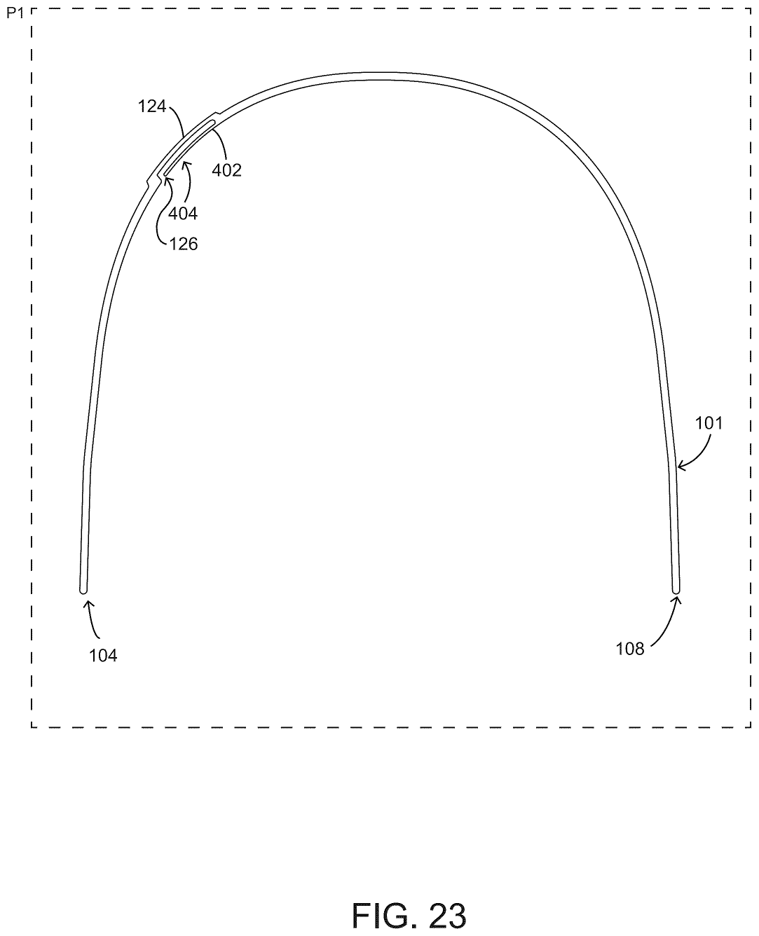

In some embodiments, as seen the first wire 101 can include a bent portion 124 (e.g., angled segment) as seen in FIGS. 23-26. The bent portion 124 can be located between the first end 104 and the midpoint and/or between the second end 108 and the midpoint. The bent portion 124 can be integrated with and continuous to the first wire 101. The bent portion 124 can be located at any point along the first wire 101. The bent portion 124 may correspond to a tooth of the plurality of teeth. The bent portion 124 can be a plurality of bent portions 124. The bent portion 124 can be continuous with (e.g., integrated with) the wire 101. The bent portion 124 can extend away from the plurality of teeth or extend towards the plurality of teeth. The bent portion 124 can define a cavity 126. The cavity 126 can face away from the plurality of teeth or extend towards the plurality of teeth. The second wire 402 (e.g., the first portion 404 or the second portion 406) can be coupled to the first wire 101 and extend within the cavity 126. The second wire 402 can be coupled to the bent portion 124. In this case, a length of the second wire 402 can be less than a length of the cavity 126. The second wire 402 can extend towards the midpoint or the first end 104. The second wire 402 can also extend towards the second end 108. The length of the bent portion 124 can be less than the length of the first portion 404 and the second portion 406. The length of the bent portion 124 can be less than the length of the first wire 101.

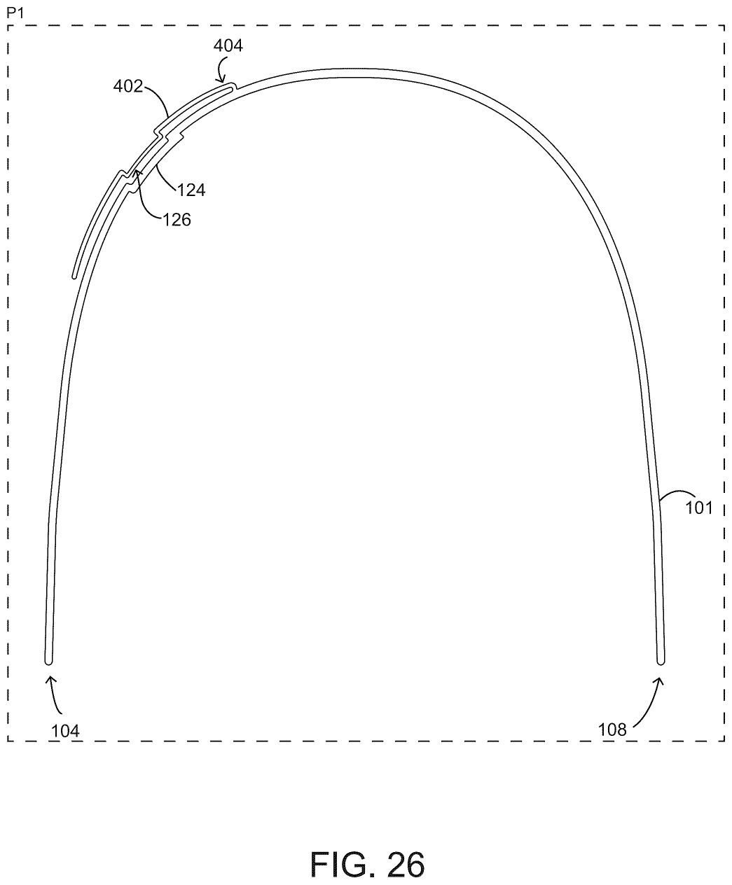

In some embodiments, the length of the second wire 402 is greater than the length of the cavity 126. For example, as seen in FIG. 26, the second wire 402 can be coupled to the first wire 101 between the first end 104 and the midpoint and extend towards the first end 104 and along the cavity 126. In this case, the second wire 402 can also include a bent portion 408. The bent portion 408 can be congruent with the cavity 126.

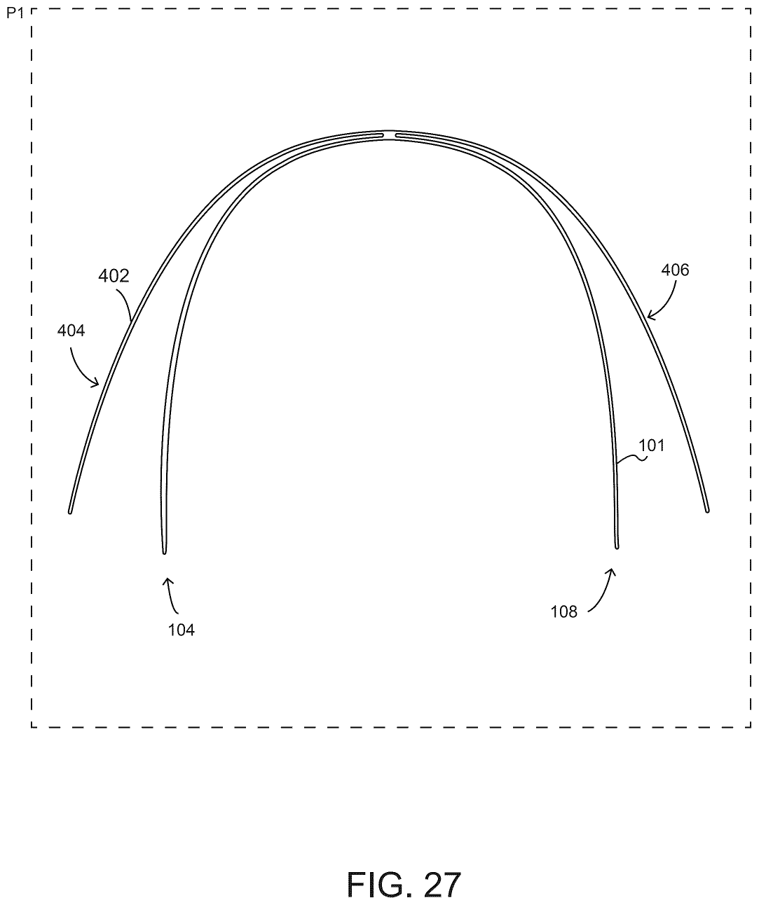

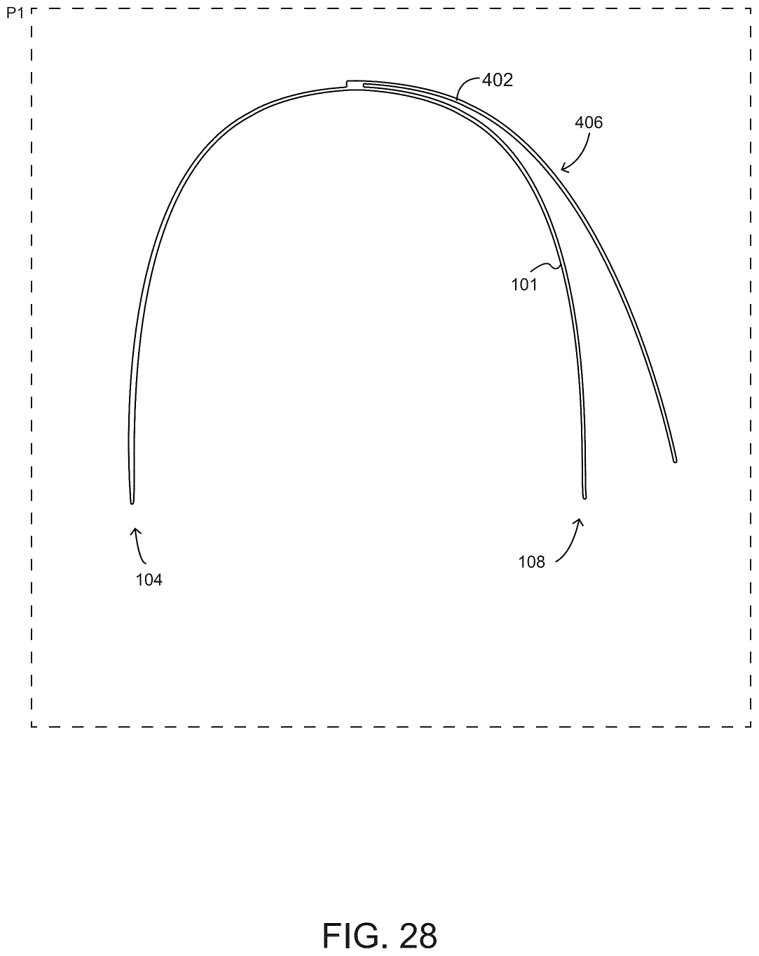

In some embodiments, as seen in FIGS. 27-28, the second wire 402 can have a width greater than the first wire 101. The second wire 402 can be expandable. The second wire 402 can have a different curvature than the first wire 101. The second wire 402 can be coupled to the first wire 101 and expand further away from the plurality of teeth than the first wire 101. In some embodiments, as seen in FIG. 28, the first portion 404 or the second portion 406 can be coupled to the first wire 101. The first portion 404 can be coupled at the midpoint of the first wire 101 and extend towards the first end 104. The first portion 404 can have a width greater than the first wire 101 (e.g., extends away from the first wire 101). The first portion 404 can be expandable. The second portion 406 can be coupled at the midpoint of the first wire 101 and extend towards the second end 108, as seen in FIG. 28. The second portion 406 can have a width greater than the first wire 101 (e.g., extends away from the first wire 101). The second portion 406 can be expandable.

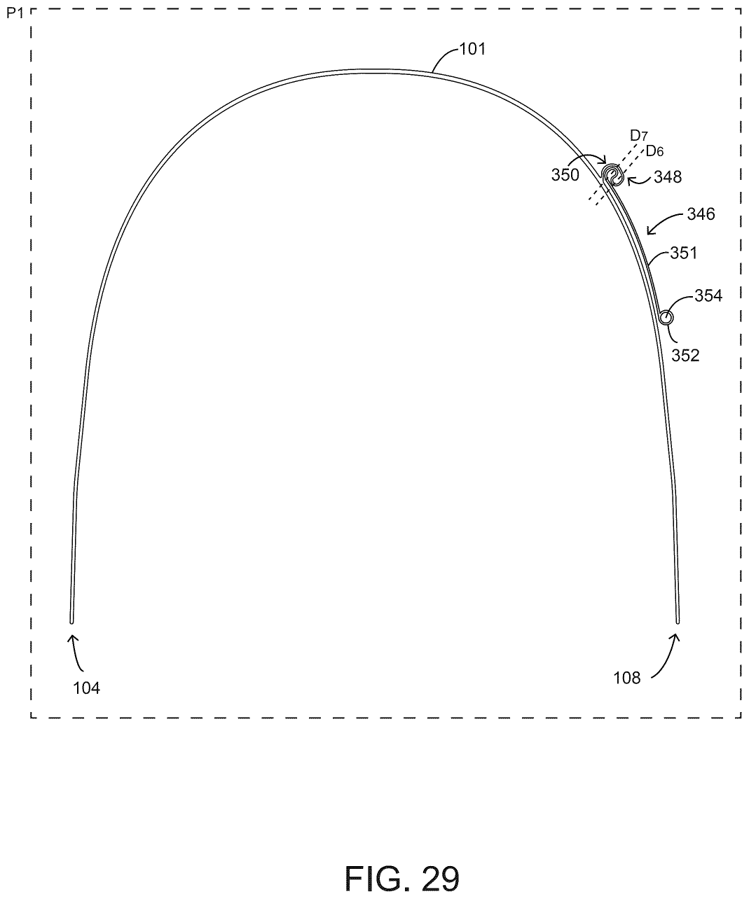

In some embodiments, as seen in FIGS. 29-32, the wire 101 can include a closing spring 346 (e.g., space closer). The closing spring 346 can extend across at least one tooth and close (e.g., decrease) a gap between adjacent teeth. The closing spring 346 can maintain a force (e.g., spring force) to close the gap between adjacent teeth. The closing spring 346 can extend from the wire 101 and face away from the plurality of teeth. The closing spring 346 can include a first curved portion 348 extending in a sixth direction D6. The closing spring 346 can include a second curved portion 350 extending in a seventh direction D7. The seventh direction D7 can be opposite of the sixth direction D6. The second curved portion 350 can extend from the first curved portion 348. In some implementations, the closing spring 346 can include the loop 308.

The closing spring 346 can also include a connection portion 351 (e.g., connector, connector wire) extending along the wire 101 from the second curved portion 350. The closing spring 346 can include a circular portion 352 extending around an aperture 354. The circular portion 352 can extend from the connection portion 351. The aperture 354 can be coupled to the bracket 105 located on tooth. For example, the circular portion 352 can extend around the bracket 105 or be located within the slot 202 of the bracket 105. The first curved portion 348 and the second curved portion 350 can provide a force to close a distance (e.g., space) between the teeth that the closing spring 346 is coupled to. The connection portion 351 can extend across at least one tooth. For example, the first curved portion 348 and the second curved portion 350 can be located at a first tooth. The circular portion 352 can be located at a second tooth with the aperture 354 coupled to the bracket 105 on the second tooth. There can be at least one tooth between the first tooth and the second tooth. The connection portion 351 can extend from the first tooth to the second tooth. A length of the connection portion 351 can determine a force of the closing spring 346. For example, a greater length of the connection portion 351 can correspond to a greater force imparted on the teeth by the closing spring 346. A thickness of the closing spring 346 may also increase as the length of the connection portion 351 increases.

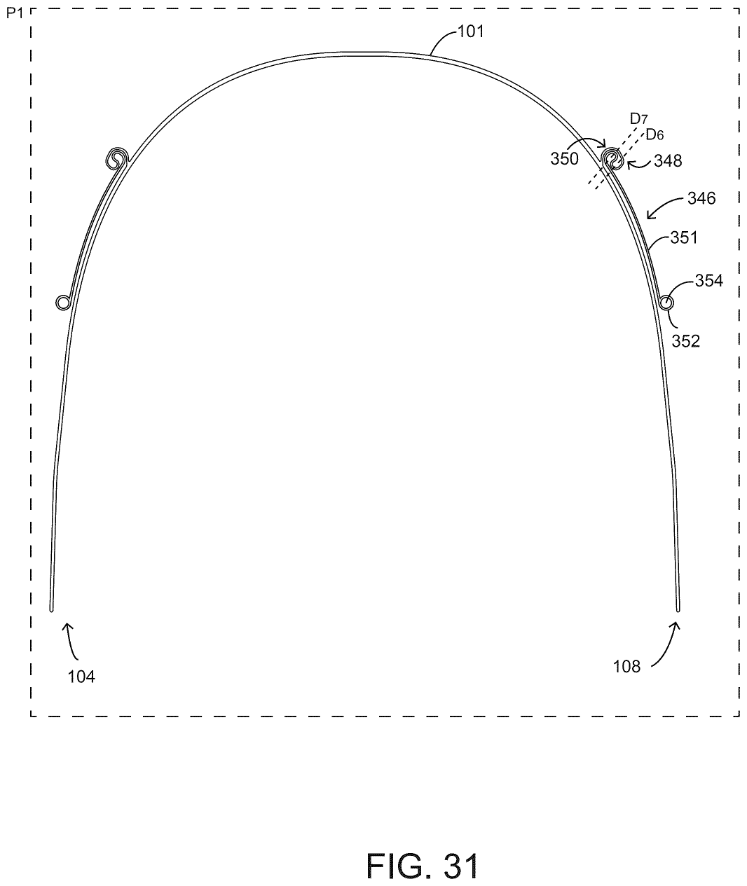

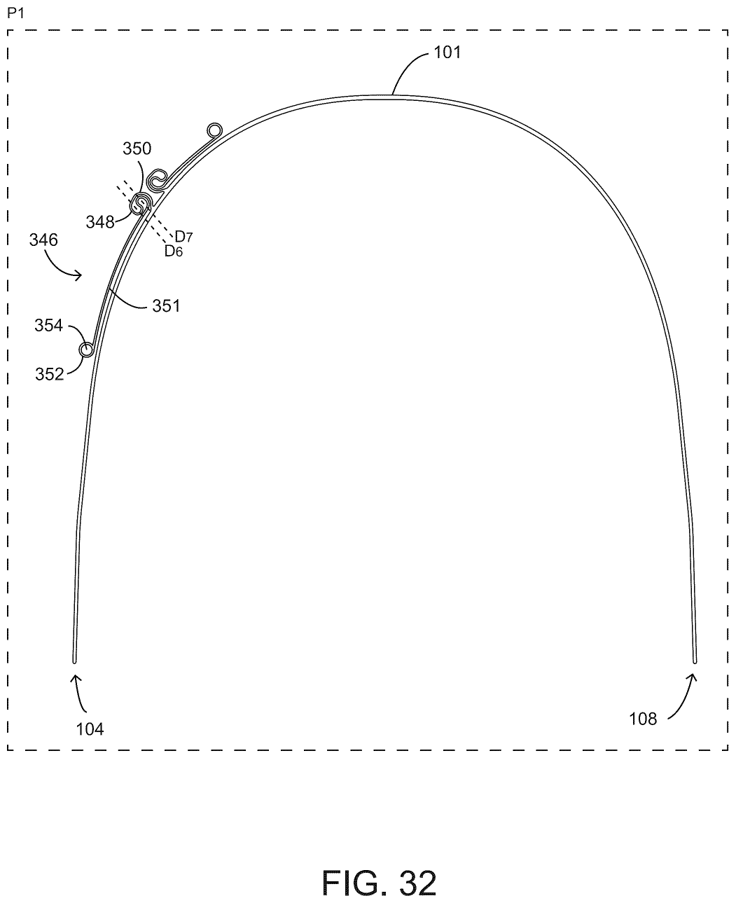

In some embodiments, as seen in FIG. 31, the wire 101 can include a plurality of the closing spring 346. One of the plurality of the closing spring 346 can be located between the first end 104 and the midpoint and another of the plurality of the closing spring 346 can be located between the second end 108 and the midpoint. Each of the plurality of the closing spring 346 can be positioned symmetric to each other along the wire 101. In some embodiments, as seen in FIG. 32, the plurality of the closing spring 346 can be in contact with each other. The first curved portion 348 and the second curved portion 350 of the plurality of the closing spring 346 can be in contact with each other. The plurality of the closing spring 346 can be located either between the first end 104 and the midpoint or between the second end 108 and the midpoint. A length of one of the plurality of the closing spring 346 can be less than a length of another of the plurality of the closing spring 346. A smaller length may correspond to a smaller force enacted on the tooth. The smaller length may correlate to a smaller distance between teeth compared to the one of the plurality of the closing spring 346 with a greater length.

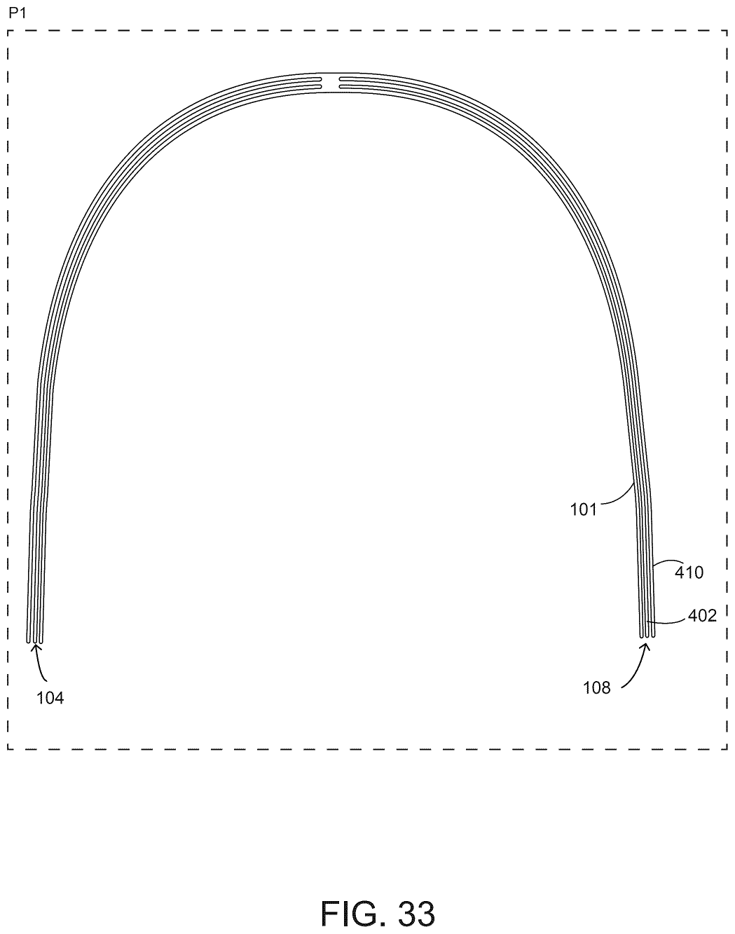

In some embodiments, the system 100 can include a third wire 410 as seen in FIG. 33. The third wire 410 can also be arched-shaped. The third wire 410 can include the material. The material can be a flexible material. The material can be a flexible, metallic material. The material can be nickel titanium (NiTi). The material can also be stainless steel. The material can be a shape memory alloy. The third wire 410 can be coupled to the first wire 101 and the second wire 402. The third wire 410 and the second wire 402 can be coupled at the midpoint of the first wire 101. A length of the third wire 410, the second wire 402 and the first wire 101 can be equal. The first wire 101, the second wire 402 and the third wire 410 may be congruent. An addition of the third wire 410 can impart a greater force to align the teeth. The third wire 410 can also facilitate alignment of the teeth with the dental arch. The addition of the third wire 410 allows for greater variability and capability to adjust the forces. For example, the system 100 including the first wire 101, the second wire 402, and the third wire 410 has a greater variability and capability of force adjustment that the system 100 including the first wire 101 and the second wire 402. The first wire 101, the second wire 402, and the third wire 410 may be coupled at any point along the first wire 101.

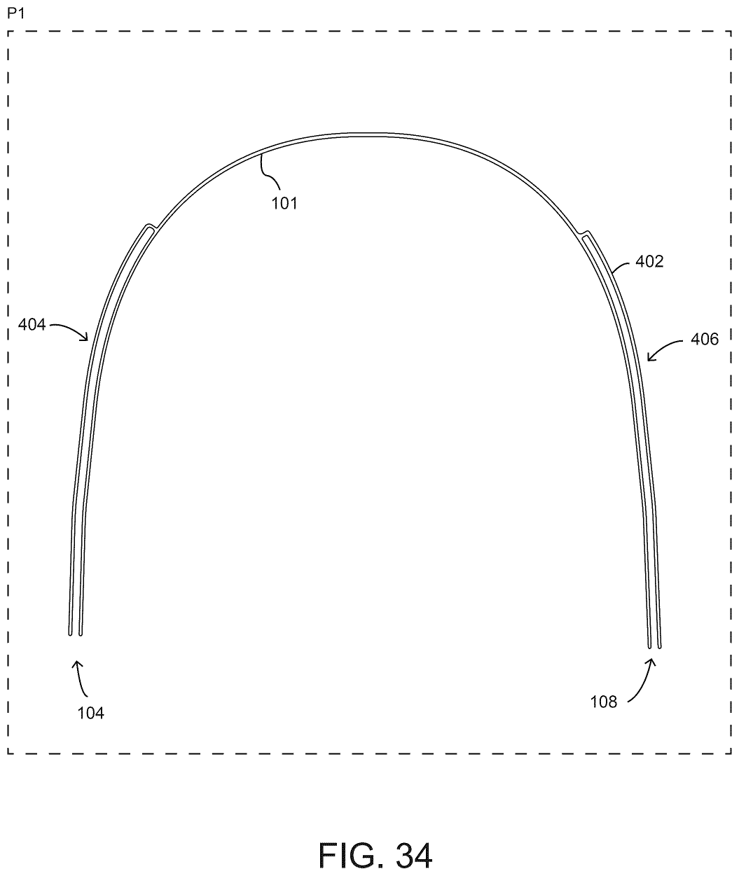

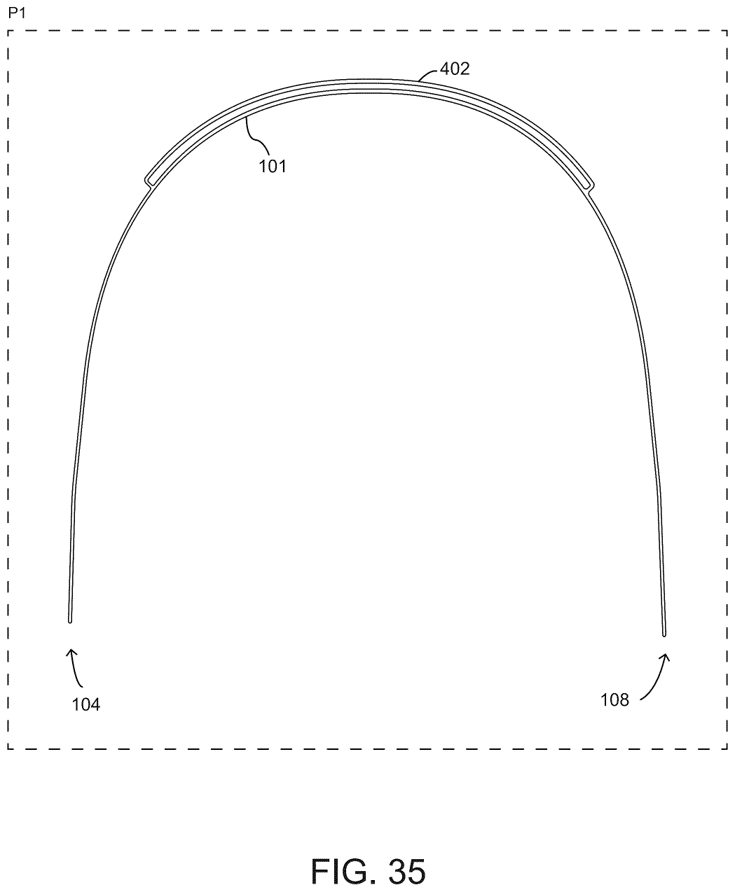

In some embodiments, both the first portion 404 and the second portion 406 are coupled to the first wire 101 as seen in FIG. 34. The first portion 404 can be coupled between the first end 104 and the midpoint and extend towards the first end 104. The second portion 406 can be coupled between the second end 108 and the midpoint and extend towards the second end 108. The second wire 402 and/or the third wire 410 can also extend across the midpoint of the first wire 101. For example, the second wire 402 can be coupled at a point between the first end 104 and the midpoint and at another point between the second end 108 and the midpoint as seen in FIG. 35. In this case, the second wire 402 can extend across the midpoint. The second wire 402 can facilitate alignment of teeth along the front of the upper dental arch and/or the lower dental arch.

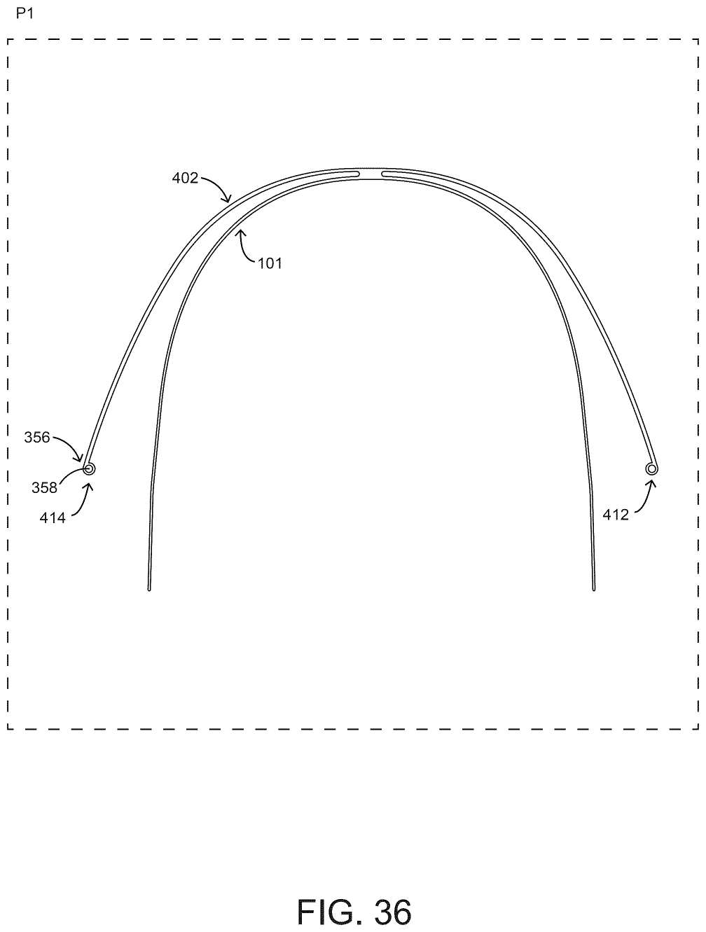

In some embodiments, the plurality of treatment members 103 further includes a plurality of rings 356 as seen in FIG. 36. The plurality of rings 356 can be continuous with at least one of the first wire 101 and/or the second wire 402. The plurality of rings 356 can be located at a first end 412 and a second end 414 of the second wire 402. The plurality of rings 356 extend around an aperture 358. The plurality of rings 356 can be connected to and in contact with at least one of the plurality of brackets 105. The teeth that the at least one of the plurality of brackets 105 is attached to can move buccally (e.g., side of teeth facing inside of cheeks) and expand due to force enacted by the plurality of rings 356.

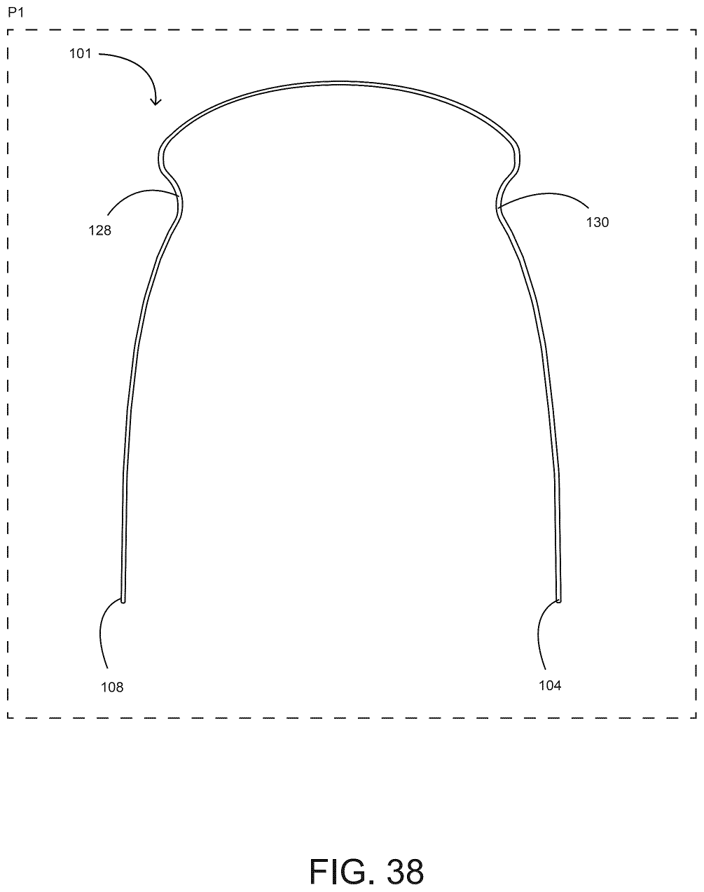

In some embodiments, the wire 101 has a portion with a biconcave shape as seen in FIG. 38. For example, the wire 101 includes a first concave section 128 and a second concave section 130. The first concave section 128 and the second concave section 130 face away from each other in that a section of the wire 101 including the first concave section 128 and the second concave section 130 has a width less than a width of the wire 101 at the first end 104 and the second end 108. The wire 101 has symmetrical convergence and divergence. The first concave section 128 and the second concave section 130 can be located equidistant along the wire 101 form the midpoint. The wire 101 can have a bread shape. The wire 101 having the biconcave shape may be in contact with a lingual side (e.g., side facing the tongue) of the plurality of teeth. The wire 101 having the biconcave shape may be used in maxillary expansion (e.g., widening upper jaw) procedures.

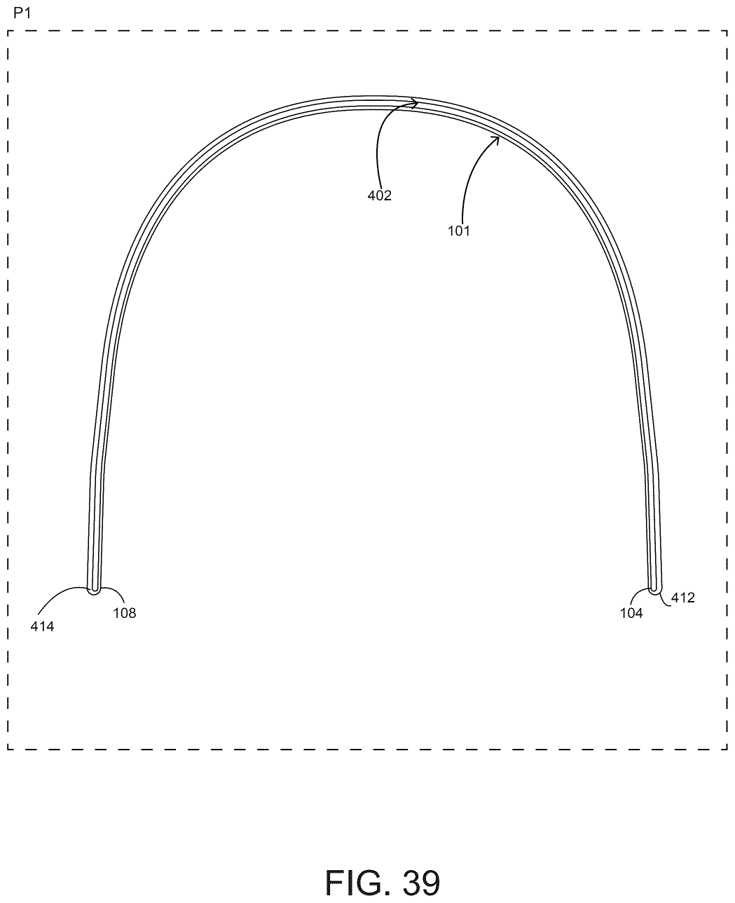

In some embodiments, the first wire 101 and the second wire 402 are coupled at both ends as seen in FIG. 39. For example, the first end 104 is coupled to the first end 412 and the second end 108 is coupled to the second end 414. In some embodiments, the first end 104 is contiguous with the first end 412 and the second end 108 is contiguous with the second end 414. In this case, the second wire 402 is thicker than the first wire 101. The system 100, in these embodiments, may be used to intrude (e.g., move teeth towards a bone socket) the teeth. The first wire 101 is connected to and in contact with the plurality of brackets 105. The second wire 502 may be located above the plurality of brackets 105.

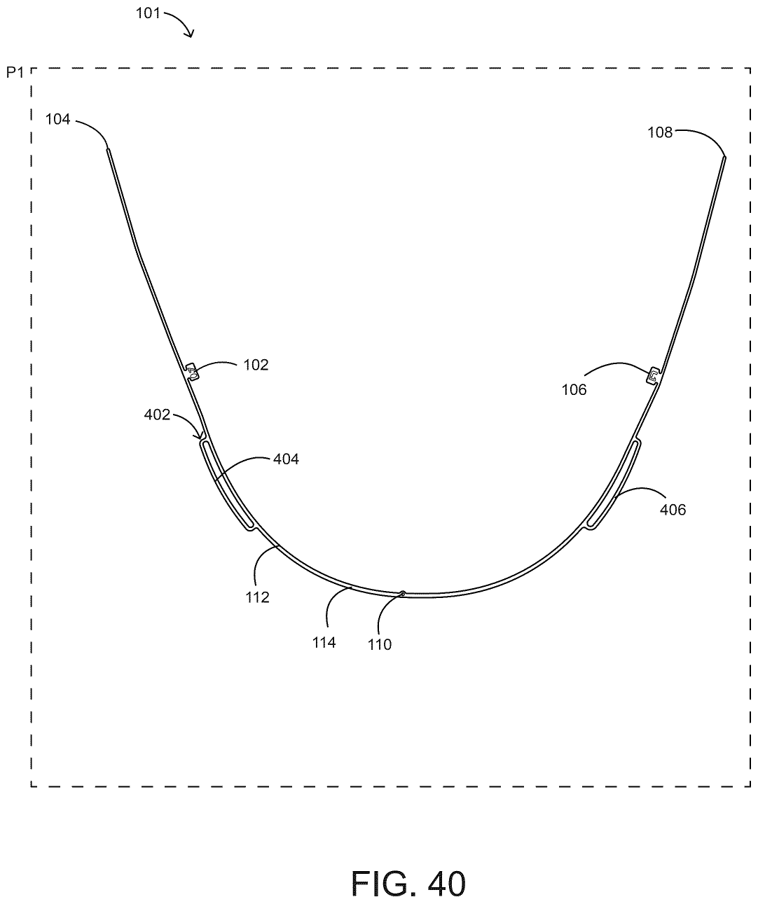

In some embodiments, the first portion 404 has a length less than the wire 101 and is located between the first end 104 and the midpoint as seen in FIG. 40. The second portion 406 has a length less than the wire 101 and is located between the second end 108 and the midpoint. The first portion 404 may have a length equal to the second portion 406. In some embodiments, a length of the first portion 404 is different than a length of the second portion 406. These embodiments of the system 100 may also be used to intrude the teeth, such as specific teeth like the canine.

In some embodiments, the first identifier 102 is not located at the first end 104 and/or the second identifier 106 is not located at the second end 108 as seen in FIG. 40. The first identifier 102 may be located between the first end 104 and the midpoint. The second identifier 106 may be located between the second end 108 and the midpoint. The first identifier 102 and the second identifier 106 may have a square and/or rectangular shape. The first identifier 102 and the second identifier 106 may have a circular shape. The first identifier 102 and the second identifier 106 may extend from the wire 101. The first identifier 102 and the second identifier 106 may identify whether the wire 101 is designed for the upper or lower arch.

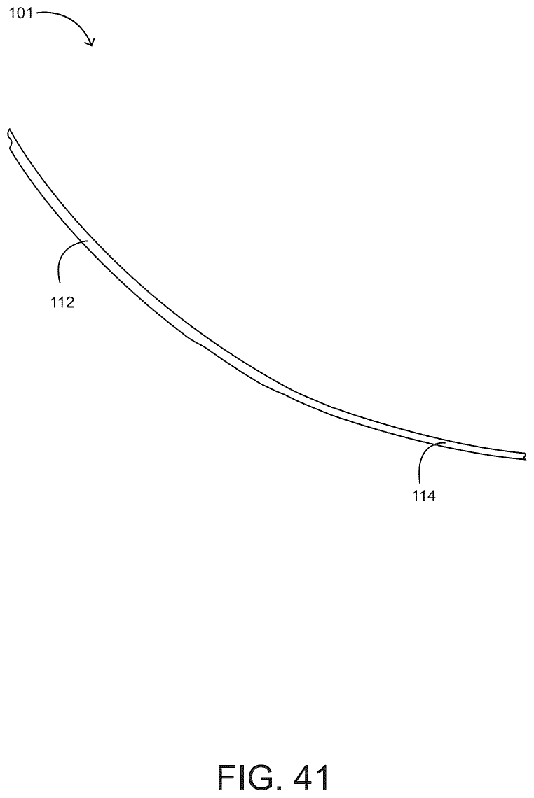

In some embodiments, the varying thickness of the wire 101 is at least one of step wise and/or gradual. For example, as seen in FIG. 41, the changes in thickness between, for example, the first location 112 and the second location 114 occur at an angle between 60 to 100 degrees, inclusive. As seen in FIG. 41, the changes in thickness are gradual over a length of the wire 101.

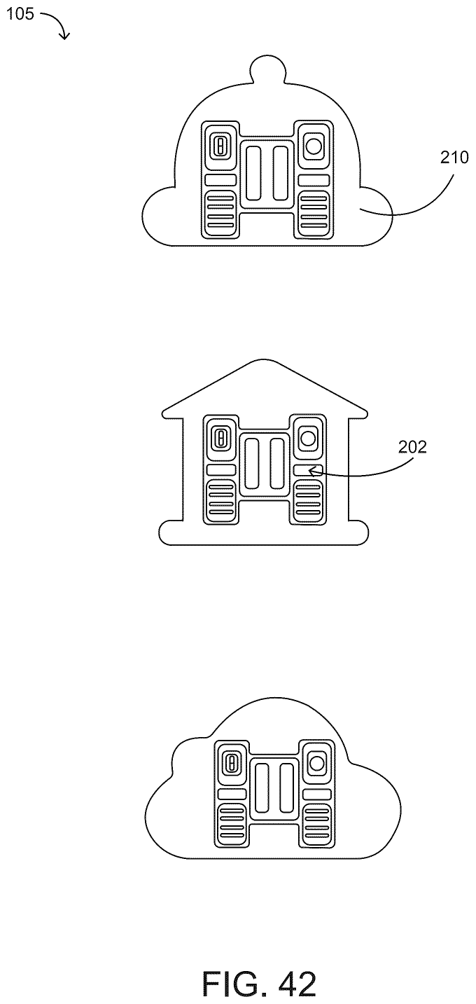

In some embodiments, as seen in FIG. 42, each of the plurality of brackets 105 can include a backing 210. The backing 210 are in direct contact with and coupled to the plurality of teeth. The backing 210 adheres the plurality of brackets 105 to the plurality of teeth. The backing 210 is integrated with each of the plurality of brackets 105. Each of the plurality of brackets 105 may extend from the backing 210. In some embodiments, the backing 210 is coupled to the plurality of brackets 105. The backing 210 can have various shapes. For example, the backing 210 can have a hat, bell, house, star, fish, butterfly, flower, heart, circle, cloud, letter (e.g., “s”), or state (e.g., Texas) shape, among others. In some embodiments, the plurality of brackets 105 includes a hook (not shown). The plurality of treatment members 103 may attach to the hook. For example, the hook extends through the aperture 358 of the plurality of rings 356. The hook can also extend through the aperture 354 of the closing spring 346 as well as the aperture 344 of the link 334. The hook may provide enhanced securement compared to the plurality of slots 202 for the aperture 358, the aperture 354, and the aperture 344.

In some embodiments, the plurality of slots 202 can include a first slot and a second slot. The first slot can receive the first wire 101 and the second slot can receive the second wire 402. In some embodiments, the plurality of slots 202 are tubes. In this case, the wire 101 is received in and extends through the tube. The plurality of slots 202 can include one or more tubes. For example, the first wire 101 extends through a first tube, the second wire 402 extends through a second tube, and the third wire 410 extends through a third tube. The plurality of brackets 105 can include any number of slots and/or tubes to receive at least one of the first wire 101, the second wire 402, the third wire 410, and/or the plurality of treatment members 103.

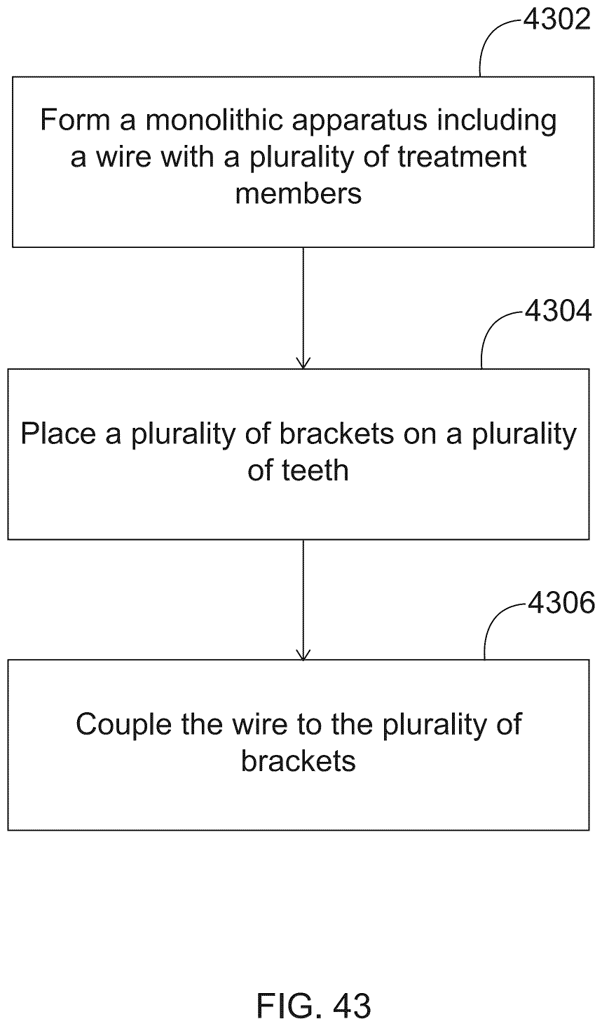

FIG. 43 depicts a method 4300 of forming and applying a wire with treatment members to a patient. At block 4302, a monolithic apparatus is formed. The monolithic apparatus can include a wire (e.g., the wire 101) and the plurality of treatment members 103 (e.g., the hooks 302, the loops 308, the first protrusions 314, the second protrusions 316, the aligners 318, the first markers 328, the second markers 330, and/or the links 334). The monolithic apparatus can be formed on a single plane. The monolithic apparatus can be formed from a sheet including a metallic metal. The monolithic apparatus can be formed by at least one of laser cutting, water jet cutting, stamping, and/or electric discharge machining of the sheet. The metallic metal can be NiTi. The monolithic apparatus can also be 3D printed. At block 4304, a plurality of brackets (e.g., the plurality of brackets 105) are placed on a plurality of teeth of a patient. The plurality of brackets can be coupled to the plurality of teeth by, for example, an adhesive. At block 4306, the wire is coupled to the plurality of brackets. The wire can be coupled by, for example, placing the wire in a plurality of slots (e.g., the plurality of slots 202) of the plurality of brackets. The plurality of brackets can be tightened to maintain the wire within the plurality of slots. The wire can also be coupled to the plurality of brackets via the O-rings 107.

In some implementations, the system 100 is designed (e.g., customized, created) per patient using a machine learning model. The machine learning model can translate verbal commands (e.g., words) from a doctor (e.g., orthodontist) into the system 100. For example, responsive to the doctor providing verbal commands that a gap between teeth should be closed, the machine learning model can process the verbal command and design the system 100 to include at least one loop 308. The machine learning model can leverage advanced algorithms (e.g., artificial intelligence (AI), machine learning, deep neural networks) to process verbal commands and convert the verbal commands into the system 100 to achieve a desired teeth arrangement for the patient. The machine learning model can also include patient records and a target alignment of teeth to generate configurations of the system 100 such as locations of the plurality of treatment members 103 or thicknesses of the wire 101. The machine learning model can use supervised learning and receive inputs such as OTA, FTA, images, panoramic radiographs, initial cephalometric radiographs, and facial scans. The machine learning model can use the inputs to generate the configurations of the system 100. The machine learning model can be trained on alignment, sectioning, staging, attachment design, and wire sequencing. The machine learning model can customize the system 100 based on ethnicity, sex, root size (e.g., of the teeth), and/or periodontal health (e.g., health of gums, bones, etc.). An output of the machine learning model can be used to manufacture (e.g., generate) the system 100 per patient. The machine learning model can output one or more of the system 100 which can be used iteratively (e.g., over time) by the patient to correct alignment of their teeth.

In some implementations, the system 100 can include a mesh. In this case, the system 100 does not include the wire 101, the plurality of treatment members 103, or the plurality of brackets 105. The mesh can be composed of a metallic material. The metallic material can include at least one of NiTi, stainless steel, or a shape memory alloy, among others. The mesh can cover the plurality of teeth and align the plurality of teeth. The mesh can be molded (e.g., manufactured) to fit to the plurality of teeth, and a shape of the mesh can be progressively (e.g., iteratively, over time) altered to align the plurality of teeth. The mesh can be removable. The mesh can include regions with positive, negative, or zero curvature to target movement of certain teeth. The mesh can also provide uniform force to move the teeth.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other example arrangements, and that such variations are intended to be encompassed by the present disclosure.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A system, comprising:
a wire extends along a plane, the wire comprising a plurality of treatment members on the plane; and
a plurality of brackets to be located on a plurality of teeth of a patient, each of the plurality of brackets to be coupled to the wire;
wherein the wire has a first thickness at a first location and a second thickness at a second location, the first thickness and the second thickness being different;
wherein the wire and the plurality of treatment members are a monolithic apparatus formed from a sheet comprising a metallic material.

2. The system of claim 1, wherein the plurality of treatment members comprise one or more loops, the one or more loops continuous with the wire, comprising:
a first curved portion extending in a first direction on the plane; and
a second curved portion extending in a second direction opposite the first direction.

3. The system of claim 1, wherein the plurality of treatment members comprise one or more hooks, comprising:
a first portion extending from the wire at a first angle between 30 to 80 degrees, inclusive, relative to the wire on the plane; and
a second portion extending from the first portion at a second angle between 30 to 90 degrees, inclusive, relative to the first portion on the plane.

4. The system of claim 1, wherein the plurality of treatment members comprise one or more first protrusions and one or more second protrusions, wherein:
the one or more first protrusions extend from the wire on the plane and face the plurality of teeth; and
the one or more second protrusions extend from the wire on the plane and face away from the plurality of teeth.

5. The system of claim 4, wherein the wire comprises one or more curved segments, the one or more curved segments aligning with a positioning of the plurality of teeth.

6. The system of claim 1, wherein the plurality of treatment members comprise one or more aligners, the one or more aligners continuous with the wire, comprising:
a first curved portion; and
a second curved portion continuous with the first curved portion;
wherein the first curved portion and the second curved portion define a receiving space comprising a protrusion;
wherein the receiving space is configured to receive at least one of the plurality of teeth, and the first curved portion and the second curved portion configured to extend to the at least one of the plurality of teeth.

7. The system of claim 1, wherein the plurality of treatment members comprise one or more first markers and one or more second markers aligned with the plurality of brackets, wherein:
the one or more second markers extend from the wire and face away from the plurality of teeth, the second markers comprising apertures.

8. The system of claim 1, wherein the wire comprises a first bar, a second bar parallel to the first bar, and an aperture between the first bar and the second bar, the first bar and the second bar continuous with the wire.

9. The system of claim 1, wherein the plurality of treatment members comprise one or more links, comprising:
a protrusion extending from the wire in a first direction on the plane;
a first curved portion extending from the protrusion in a second direction on the plane;
a second curved portion extending from the first curved portion in a third direction opposite the second direction;
a straight portion extending from the second curved portion in the first direction; and
a circular portion extending from the straight portion and around an aperture, the aperture configured to couple to at least one of the plurality of brackets.

10. The system of claim 1, wherein the plurality of brackets comprise a plurality of slots, the plurality of slots having a first portion and a second portion, the first portion having a first height and the second portion having a second height, the second height greater than the first height.

11. The system of claim 1, wherein the plane is an imaginary plane.

12. The system of claim 1, wherein the metallic material is nickel titanium.

13. The system of claim 1, the wire further comprising:
a first identifier located at a first end of the wire;
a second identifier located at a second end of the wire; and
a third identifier located at a midpoint on the wire between the first end and the second end.

14. A system, comprising:
a wire extending along a plane, comprising:
a plurality of treatment members on the plane;
a first identifier located at a first end of the wire;
a second identifier located at a second end of the wire; and
a third identifier located at a midpoint on the wire between the first end and the second end; and
a plurality of brackets to be located on a plurality of teeth of a patient, each of the plurality of brackets to be coupled to the wire, the plurality of brackets comprising a plurality of slots, the plurality of slots having a first portion and a second portion, the first portion having a first height and the second portion having a second height, the second height greater than the first height;
wherein the wire has a first thickness at a first location and a second thickness at a second location, the first thickness and the second thickness being different;
wherein the wire and the plurality of treatment members are a monolithic apparatus comprising a metallic material.

15. The system of claim 14, wherein the metallic material is nickel titanium.

16. The system of claim 14, wherein a portion of the plurality of treatment members are continuous with the wire and a portion of the plurality of treatment members extend from the wire on the plane, the plurality of treatment members configured to align the plurality of teeth with the wire.

17. The system of claim 14, wherein the system is designed by a machine learning model.

18. A method, comprising:
forming a monolithic apparatus comprising a wire with a plurality of treatment members on a single plane;
placing a plurality of brackets on a plurality of teeth of a patient; and
coupling the wire to the plurality of brackets.

19. The method of claim 18, wherein the monolithic apparatus is formed from a sheet comprising a metallic metal, the monolithic apparatus formed by at least one of laser cutting, water jet cutting, stamping, or electric discharge machining of the sheet.

20. The method of claim 18, wherein the monolithic apparatus is 3D printed.
